(19) United States
(12) Patent Application Publication
(10) Pub. No.: US 2025/0353443 A1
(43) Pub. Date: Nov. 20, 2025

(54) Container Mount System

(71) Applicant: YETI Coolers, LLC, Austin, TX (US)

(72) Inventors: Matthew Shaffer Corbin, San Antonio, TX (US); George N. Popa, III, Lakeway, TX (US)

(21) Appl. No.: 19/199,766

(22) Filed: May 6, 2025

Related U.S. Application Data
(60) Provisional application No. 63/647,458, filed on May 14, 2024.

(51) Int. Cl. B60R 9/06

(52) U.S. Cl. CPC B60R 9/06

(57) ABSTRACT

A container mount system may provide a secure and efficient means for attaching containers to vehicles, such as UTVs, ATVs, golf carts, or architectural locations, such as walls, fences, or decks. The container mount system may securely attach a container, such as a storage container, a tool box, a cargo box, a storage box, a gear box, an insulating container, or a cooler, etc. The system may include a base plate, a back plate, and two latch assembly brackets designed to lock the container in place, ensuring stability and ease of use during transportation on the golf course.

### CROSS-REFERENCE TO RELATED APPLICATION

This application claims priority to and benefit of U.S. Provisional Patent Application No. 63/647,458, filed on May 14, 2024. The contents of the above listed application are incorporated herein by reference in its entirety for any and all non-limiting purposes.

### BACKGROUND

Containers and coolers are often used for transporting items and storing items on vehicles or other mounting locations. However, securely fastening these containers or coolers to vehicles, utility task vehicles (UTVs), all-terrain vehicles (ATVs), golf carts, or other mounting locations can be challenging, especially over rugged terrain, leading to instability and potential spillage during transit. Existing container mount systems may lack adequate locking and securing mechanisms or fail to provide sufficient support for the containers and/or coolers. In some examples, it may be advantageous to mount a container or cooler, such as mounting a container or cooler to a vehicle, UTV, ATV, golf cart, or other mounting location. The present invention aims to address these challenges by providing a novel container mount system that securely holds a container or cooler on a vehicle, UTV, ATV, golf cart, or other mounting location.

### BRIEF SUMMARY

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

Container mount systems configured to hold a container or cooler on a vehicle, utility task vehicle (UTV), all-terrain vehicle (ATV), golf cart, or other mounting location have various features that are described herein. In some examples, the container mount system may include a base plate, a back plate assembly attached to the base plate, wherein the back plate assembly attaches to the vehicle, UTV, ATV, golf cart, or other mounting location, and a pair of latch assembly brackets that are attached to and extend from the sides of the base plate, wherein the latch assembly brackets secure and lock the container or cooler on the container mount system.

In some examples, the base plate may include a top base, a bottom base, and a base pan attached to each other with one or more fasteners. The top base may be configured to receive and hold the container or cooler and the top base may include one or more indents configured to receive feet of the container or cooler. The bottom base may include tie-down tabs that extend from the sides of the bottom base, and the tie-down tabs may include a tie-down slot to engage with and attach to the latch assembly brackets or tie-down straps to hold and secure the container or the cooler to the container mount system.

In some examples, the latch assembly brackets may include an upper latch assembly, a lower latch assembly, and a latch that provides a locking mechanism for securing the container or cooler to the container mount system. The upper latch assembly may be hingedly and/or pivotally attached to the lower latch assembly by the latch and an upper latch pin and a lower latch pin. Closing the latch may cause tension and compression between the upper latch assembly and the lower latch assembly to secure and hold the container or cooler in place on the container mount system. The latch assembly brackets may include one or more locking loops configured to receive a lock or padlock to securely lock the latch, thereby locking the latch assembly bracket and locking the container or cooler to the container mounting system.

In some examples, the back plate assembly may include a back plate that attaches to a mount tubing using a back plate horizontal bracket and one or more retaining brackets attached to the back plate. The back plate assembly may include a plurality of mount brackets configured to attach to and engage with the back plate and the portion of the vehicle, UTV, ATV, golf cart, or other mounting location, such as for example, support bars. The back plate may include a hex grid pattern with a plurality of hexagonal-shaped holes that allow the flexibility to secure the one or more mount brackets in any location, wherein the plurality of hexagonal-shaped holes may be located along the back plate and spaced in a hexagonal pattern along the back plate.

In some examples, the container mount system may be configured to hold and secure a cooler on a golf cart.

In some examples, the container mount system may be configured to hold and secure a cooler on a utility task vehicle (UTV).

In some examples, the container mount system may be configured to hold and secure a cooler on an all-terrain vehicle (ATV).

In some examples, the mounting process for the container mount system may include one or more of the following steps: mounting the back plate to a structure, such as, for example, support bars, on the vehicle, UTV, ATV, golf cart, or other mounting location using at least two mount brackets and at least four fasteners; hanging the mount tubing on the back plate horizontal bracket of the back plate and then rotating the mount tubing into position and securing the mount tubing to the back plate; sliding the base plate onto the mount tubing and securing the base plate to the back plate; mounting the container or cooler on the container mount system by locating the container or cooler on the base plate using the indents and the feet from the container or cooler; attaching the latch assembly brackets by engaging the lower bracket tab from the latch assembly brackets to the tie-down slots of the base plate; and securing the container or cooler to the container mount system with the latch assembly brackets by pivoting the latch on the latch assembly brackets and locking the container or cooler to the container mount system.

These and various other features will be described more fully herein.

### BRIEF DESCRIPTION OF THE DRAWINGS

The present invention is illustrated by way of example and not limited in the accompanying figures in which like reference numerals indicate similar elements and in which:

FIG. 1A is front perspective view of a container mount system holding a cooler according to one or more aspects described herein.

FIG. 1B is a side view of the container mount system depicted in FIG. 1A with a cooler according to one or more aspects described herein.

FIG. 2A is a front perspective view of the container mount system depicted in FIG. 1A without the cooler according to one or more aspects described herein.

FIG. 2B is a front exploded component view of the container mount system depicted in FIG. 2A according to one or more aspects described herein.

FIG. 2C is a rear exploded component view of the container mount system depicted in FIG. 2A according to one or more aspects described herein.

FIG. 2D is a front view of the container mount system depicted in FIG. 2A according to one or more aspects described herein.

FIG. 2E is a top view of the container mount system depicted in FIG. 2A according to one or more aspects described herein.

FIG. 2F is a bottom view of the container mount system depicted in FIG. 2A according to one or more aspects described herein.

FIG. 2G is a side view of the container mount system depicted in FIG. 2A according to one or more aspects described herein.

FIG. 3A is a perspective view of a base plate from the container mount system depicted in FIG. 2A according to one or more aspects described herein.

FIG. 3B is an exploded component view of the base plate depicted in FIG. 3A according to one or more aspects described herein.

FIG. 3C is a bottom perspective view of the container mount system depicted in FIG. 2A and a set of U-bolts attached to the container mount system according to one or more aspects described herein.

FIG. 3D is a front perspective view of the container mount system and U-bolts depicted in FIG. 3C with the container mount system attached to a square tubing according to one or more aspects described herein.

FIGS. 4A-4C are top views of an exemplary base plate with representations of feet from various sized containers or coolers according to one or more aspects described herein.

FIG. 5A is a perspective view of a latch assembly from the container mount system depicted in FIG. 2A according to one or more aspects described herein.

FIG. 5B is a side view of the latch assembly depicted in FIG. 5A according to one or more aspects described herein.

FIG. 5C is an exploded component view of the latch assembly depicted in FIG. 5A according to one or more aspects described herein.

FIGS. 6A-6C are partial perspective views of the latch assembly depicted in FIG. 5A in different latching configurations according to one or more aspects described herein.

FIGS. 6D and 6E are various views of a portion of the latch assembly depicted in FIG. 5A in the latched configuration according to one or more aspects described herein.

FIGS. 6F and 6G are various views of a portion of the latch assembly depicted in FIG. 5A in the unlatched configuration according to one or more aspects described herein

FIGS. 7A and 7B are front perspective views of different embodiments of a container mount system with a cooler according to one or more aspects described herein.

FIG. 8A is a perspective view of a back plate assembly from the container mount system depicted in FIG. 2A according to one or more aspects described herein.

FIG. 8B is an exploded component view of the back plate assembly depicted in FIG. 8A according to one or more aspects described herein.

FIGS. 8C-8F are various views of a mount tubing from the back plate assembly depicted in FIG. 8A according to one or more aspects described herein.

FIG. 9A is a rear view of a back plate and post mounting brackets from the container mount system depicted in FIG. 2A according to one or more aspects described herein.

FIG. 9B is a rear perspective view of the back plate and post mounting brackets depicted in FIG. 9A according to one or more aspects described herein.

FIG. 9C is a rear view of the back plate depicted in FIG. 9A according to one or more aspects described herein.

FIG. 9D is a rear perspective view of the container mount system depicted in FIG. 2A with posts and post mounting brackets according to one or more aspects described herein.

FIG. 9E is a rear perspective view of the container mount system, posts, and post mounting brackets depicted in FIG. 9D with the post mounting brackets removed according to one or more aspects described herein.

FIG. 10A is a view of the back plate and post mounting brackets depicted in FIG. 9A for use with a container mount system according to one or more aspects described herein.

FIG. 10B is a view of another back plate or mounting plate and post mounting brackets for use with the container mount system according to one or more aspects described herein.

FIG. 10C is a view of the back plate or mounting plate depicted in FIG. 10B mounted to a vehicle according to one or more aspects described herein.

FIG. 10D is a view of the back plate or mounting plate depicted in FIG. 10B mounted to a vehicle with a container mount system according to one or more aspects described herein.

FIG. 10E is a view of the back plate or mounting plate depicted in FIG. 10B mounted to a vehicle with a container mount system and a cooler according to one or more aspects described herein.

FIG. 11A is a front perspective view of another embodiment of a container mount system according to one or more aspects described herein.

FIG. 11B is a front perspective view of the container mount system depicted in FIG. 11A with a cooler according to one or more aspects described herein.

FIG. 12A is front perspective view of yet another container mount system according to one or more aspects described herein.

FIG. 12B is a front perspective view of the container mount system depicted in FIG. 12A with a cooler according to one or more aspects described herein.

FIG. 13A is a view of a golf cart with a container mount system holding a cooler according to one or more aspects described herein.

FIG. 13B is a view of another golf cart with a container mount system holding a cooler according to one or more aspects described herein.

FIG. 13C is a view of another golf cart with a container mount system holding a cooler according to one or more aspects described herein.

FIG. 13D is a view of a side by side vehicle with a container mount system holding a cooler according to one or more aspects described herein.

FIG. 13E is a view of a rear of a pick-up vehicle with a container mount system holding a cooler according to one or more aspects described herein.

FIG. 13F is a view of an internal area with a container mount system holding a cooler according to one or more aspects described herein.

FIG. 13G is a view of a deck with a container mount system holding a cooler according to one or more aspects described herein.

Further, it is to be understood that the drawings may represent the scale of different components of one single embodiment; however, the disclosed embodiments are not limited to that particular scale.

### DETAILED DESCRIPTION

Aspects of this disclosure relate to a container mount system configured to securely hold a container or cooler on a vehicle, utility task vehicle (UTV), all-terrain vehicle (ATV), golf cart, or other mounting location.

The container mount system may include a base plate, a back plate assembly, and two latch assemblies. The container mount system may address the aforementioned issues by offering a robust and versatile solution for securely attaching containers or coolers during transportation or transit, especially over rugged terrain or off-road usage, to a range of vehicles or locations, such as vehicles, UTVs, ATVs, golf carts, or other mounting locations. The base plate may serve as the foundation for the container mount system, providing a stable platform for the container or the cooler. The base plate may be designed to be securely attached to the vehicle, UTV, ATV, golf cart, or other mounting location. The back plate assembly may be positioned behind the container or the cooler and may serve to reinforce the container or cooler's stability on the vehicle, UTV, ATV, golf cart, or other mounting location. The back plate assembly may be securely attached to the base plate and may provide additional support to prevent the container or cooler from shifting or tilting during transit, especially over rugged terrain or off-road usage. The latch assemblies may include two latch assembly brackets that are attached to the base plate and are positioned on either side of the container or cooler. These latch assemblies may feature locking mechanisms or clasps that engage with corresponding elements on the container or cooler, effectively securing the container or cooler in place on the vehicle, UTV, ATV, golf cart, or other mounting location. The latch assemblies may be adjustable to accommodate container or coolers of different sizes and shapes.

The container mount system may use one or more integrated container or cooler attachment points. Additionally, the container mount system may allow for full container or cooler access while mounted to the vehicle, UTV, ATV, golf cart, or other mounting location. The container mount system may allow full access to a drainplug to allow for draining while mounted to the vehicle, UTV, ATV, golf cart, or other mounting location. The container mount system may also provide the ability to lock to the vehicle, UTV, ATV, golf cart, or other mounting location with an integrated lock or locking mount mechanism.

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope and spirit of the present disclosure.

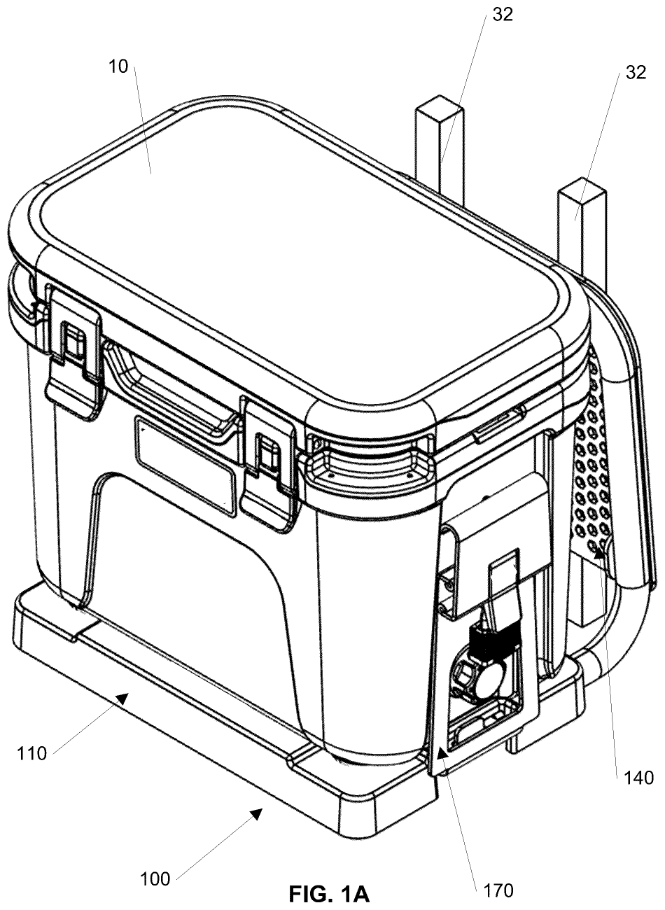

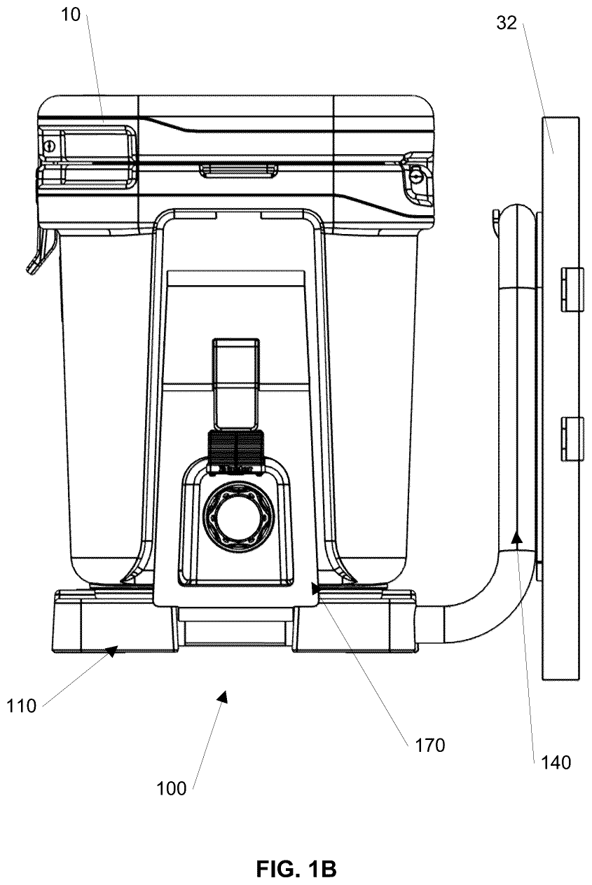

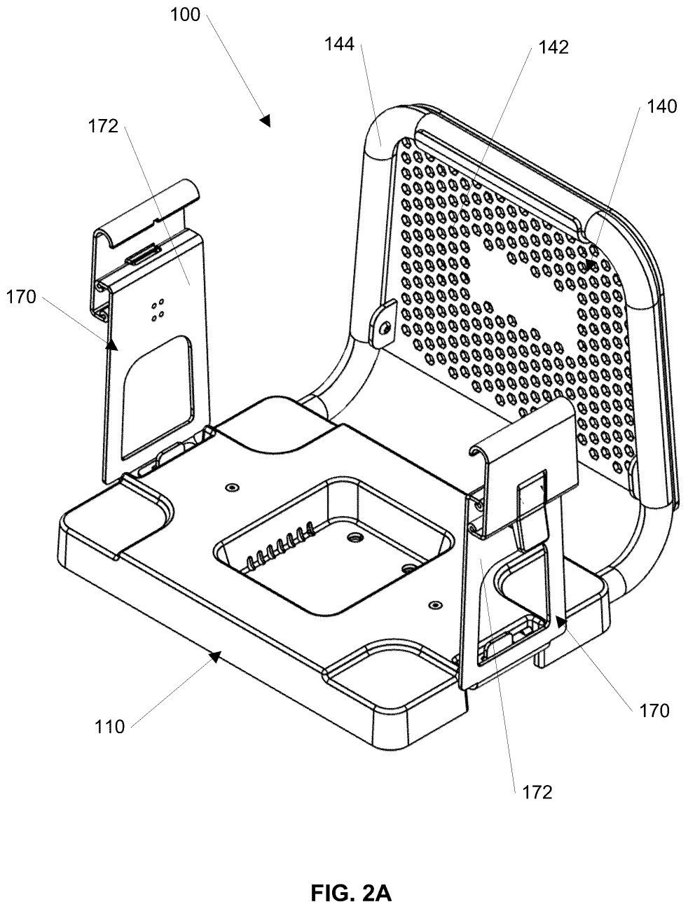

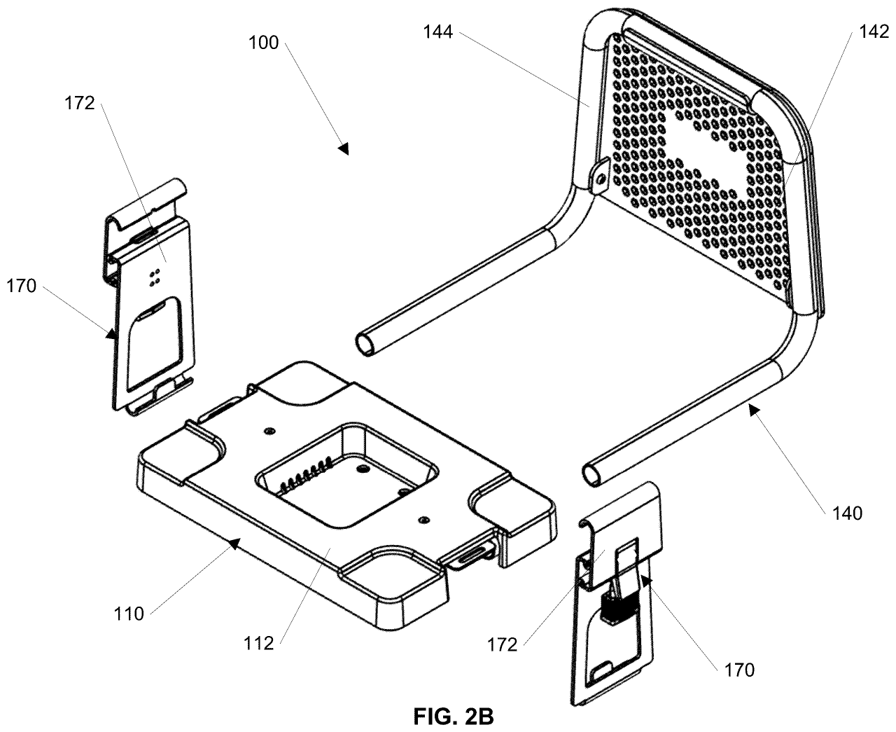

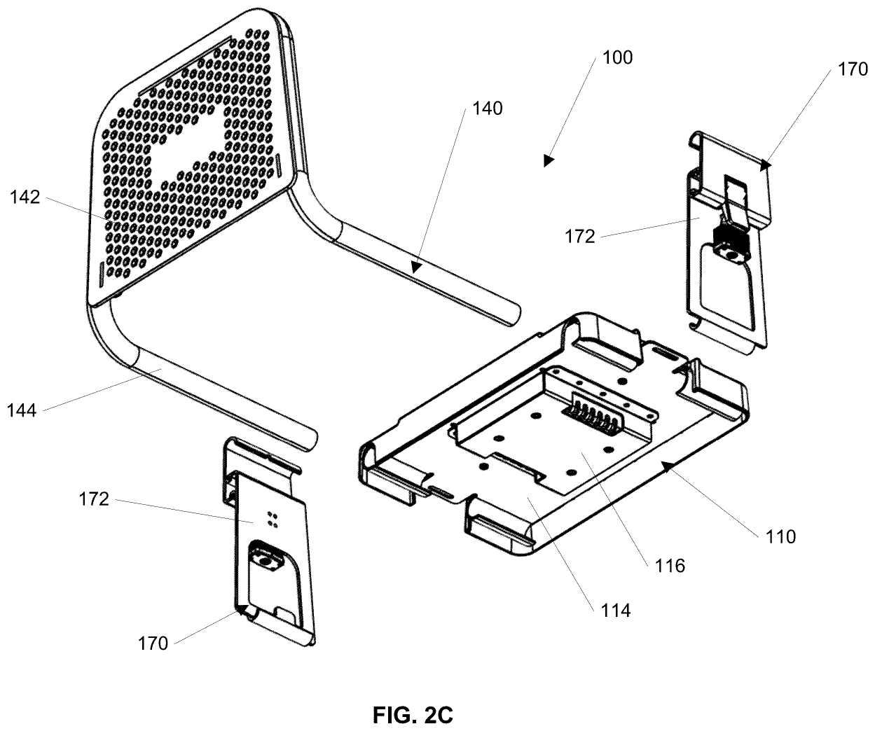

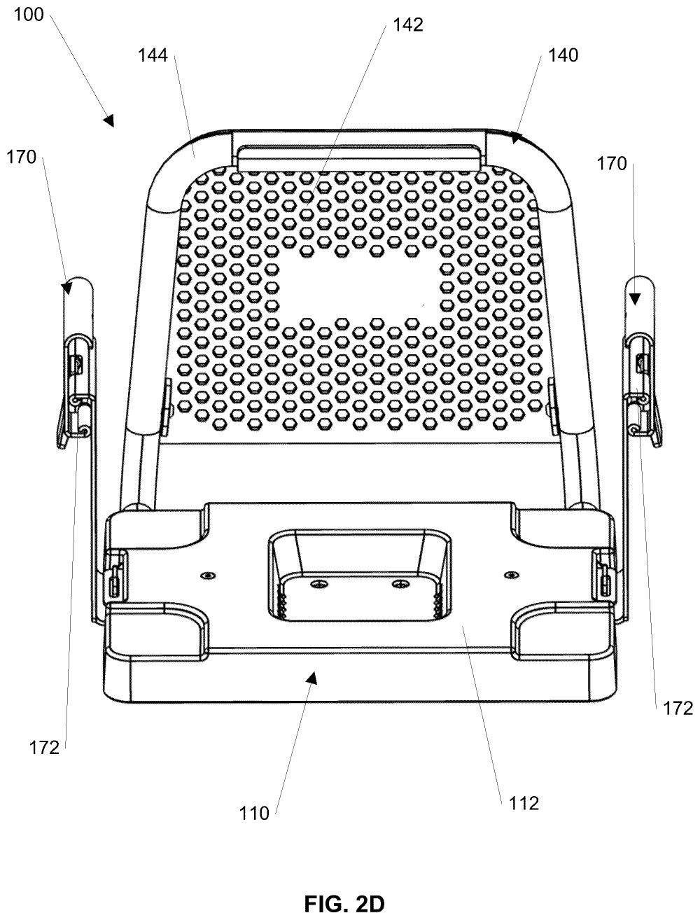

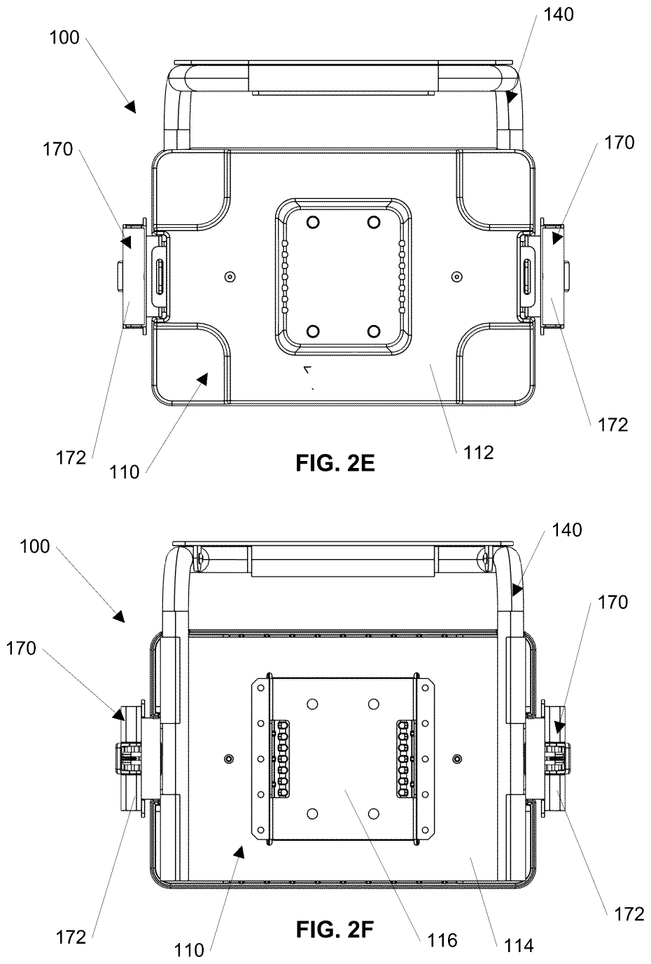

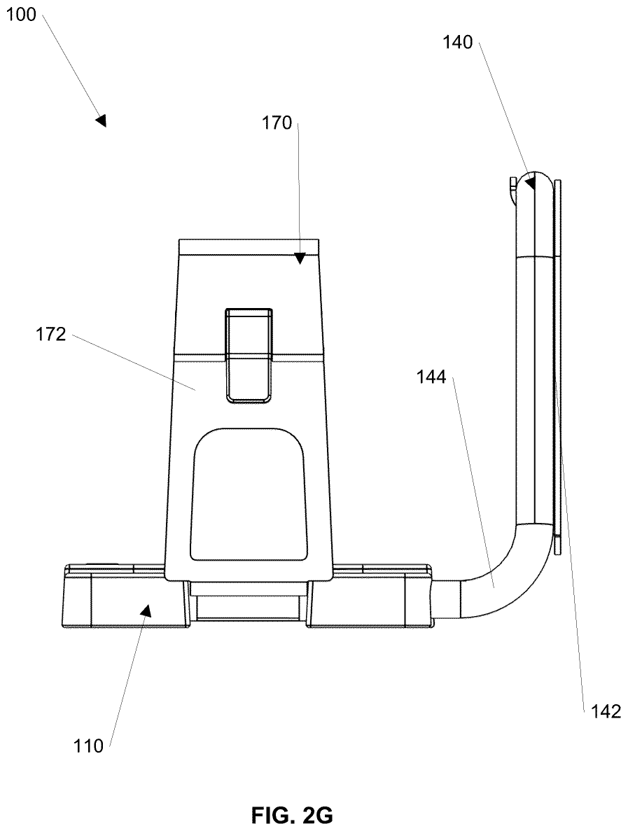

FIGS. 1A-2G depict an exemplary container mount system 100 configured to hold a container or cooler 10 on a vehicle, UTV, ATV, golf cart, or other mounting location according to one or more aspects of the invention. FIGS. 1A and 1B depict perspective views of a container mount system 100 holding a cooler 10 and attached to posts or support bars 32. FIGS. 2A-2G depict various views of the container mount system 100 without a cooler. FIGS. 2B and 2C depict a front and rear exploded component view of the container mount system 100. The container mount system 100 depicted may hold or attach to any one of a container, storage container, tool box, cargo box, storage box, gear box, insulating container, or cooler. In one example, the container mount system 100 may comprise a base plate 110, a back plate assembly 140 attached to the base plate 110, and a latch assembly 170 attached to and extending from the sides of the base plate 110. The container mount system 100 may have both horizontal and vertical mounting surfaces and capabilities.

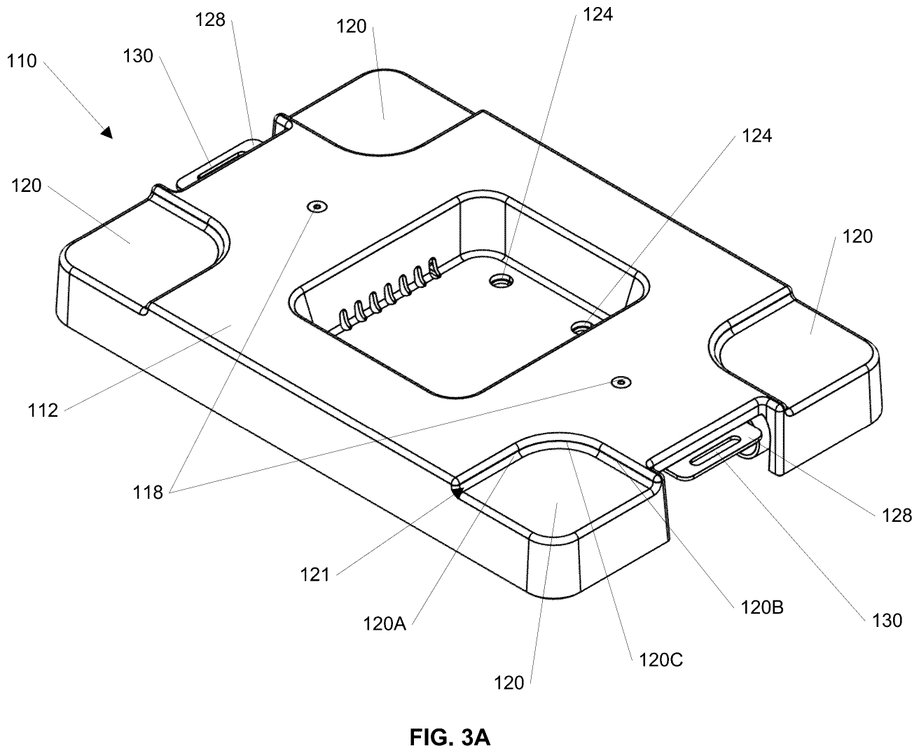

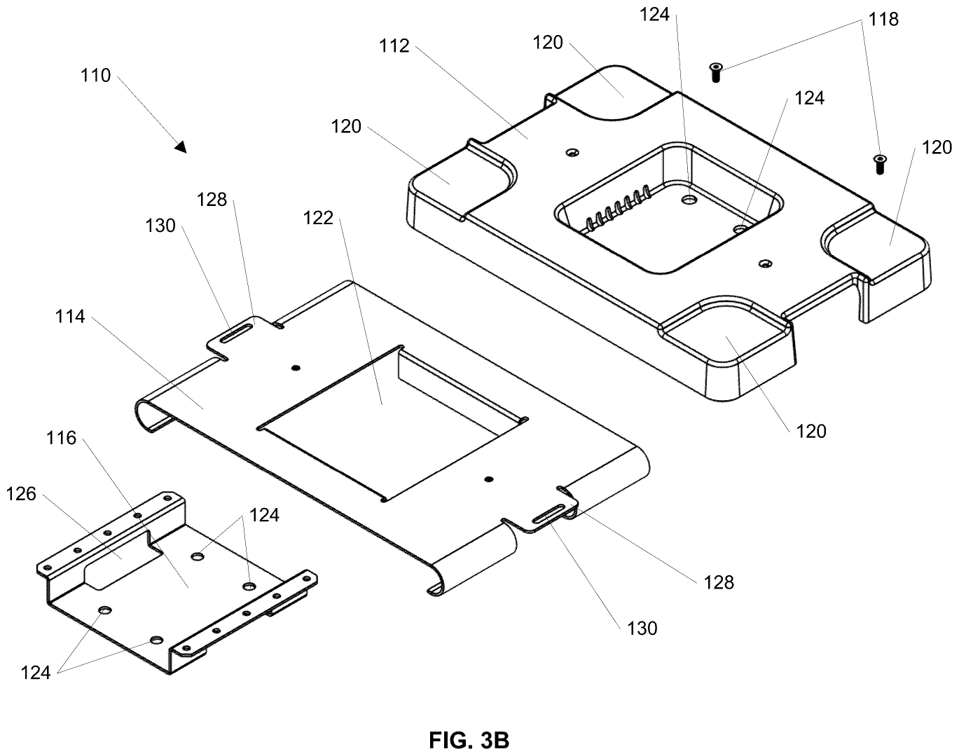

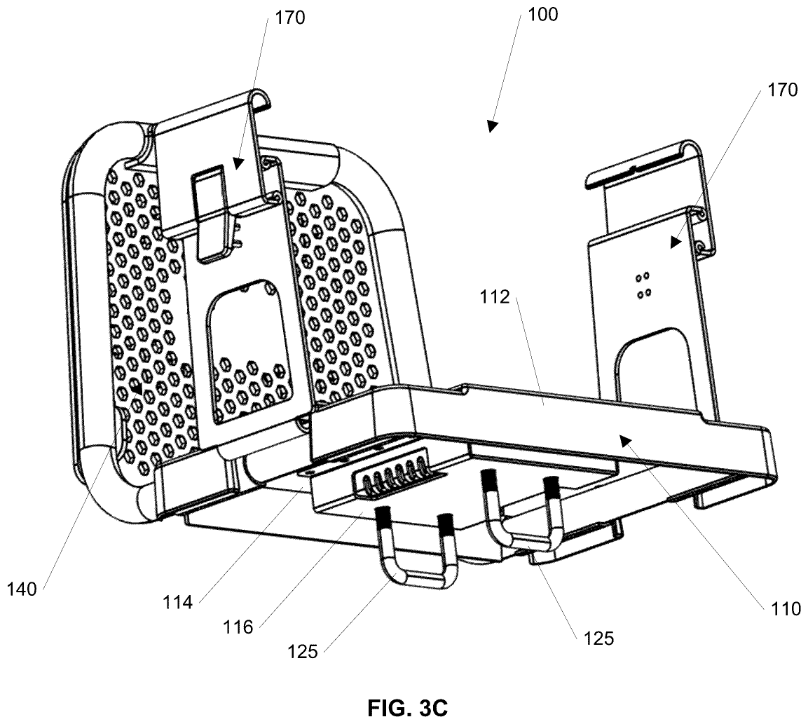

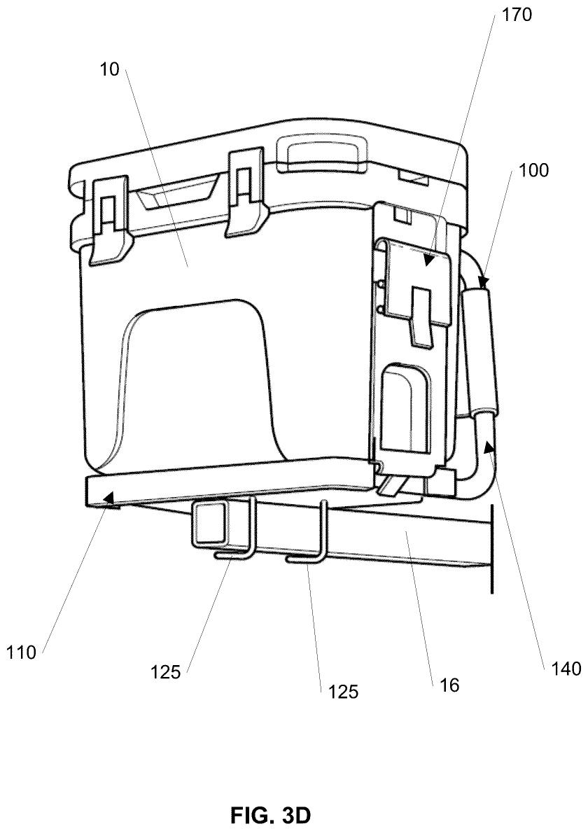

As shown in FIGS. 1A-2G, the container mount system 100 may comprise a base plate 110 configured as a foundation for the container mount system 100. FIG. 3A shows a perspective view of the base plate 110 and FIG. 3B shows an exploded component view of the base plate 110. The base plate 110 may include a top base 112, a bottom base 114, and a base pan 116. The top base 112, the bottom base 114, and the base pan 116 may be attached to each other with one or more fasteners 118.

In some examples, the base plate 110 may be attached to rear support bars or another suitable location on the vehicle, UTV, ATV, golf cart, or other mounting location. The top base 112 may be configured to receive and hold the bottom of the container or cooler 10.

The bottom base 114 may be configured to attach to and/or engage with the vehicle, UTV, ATV, golf cart, or other mounting location.

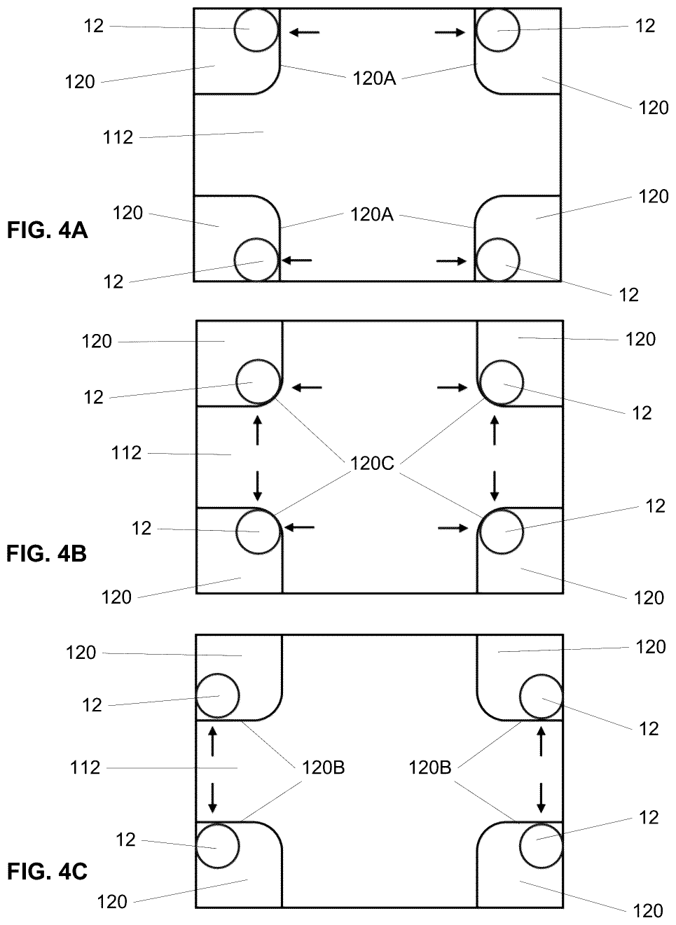

In some examples, the base plate 110 and the top base 112 may include one or more indents 120 that are configured to receive feet 12 or portions of the bottom of the container or cooler 10. The one or more indents 120 may be located on the top base 112 of the base plate 110. The one or more indents 120 may be located in each of the corners of the top base 112 of the base plate 110. The one or more indents 120 may include four indents located in each of the corners of the top base 112 of the base plate 110. Each of the indents 120 may be formed with two sides 120A, 120B and a curved section 120C. The indents 120 may also include a chamfer 121 that may extend along an entire edge of the indents 120. The chamfer 121 may also extend around a partial portion of the edge of the indents 120. The indents 120 may be configured to locate and center the feet 12 or portions of the bottom of the container or cooler 10. FIGS. 4A-4C depict top views of the base plate 110 showing the indents 120 with representations of feet 12 from various sized and shaped containers or coolers 10. As shown in FIGS. 4A-4C, the indents 120 may be configured to accommodate and accept differences in width and length spacing between the feet 12 of different containers or coolers 10. FIG. 4A shows feet 12 from a container or cooler 10 that align with the vertical side 120A of the indents 120. FIG. 4B shows feet 12 from a container or cooler 10 that align with the curved section 120C of the indents 120. FIG. 4C shows feet 12 from a container or cooler 10 that align with the horizontal side 120B of the indents 120.

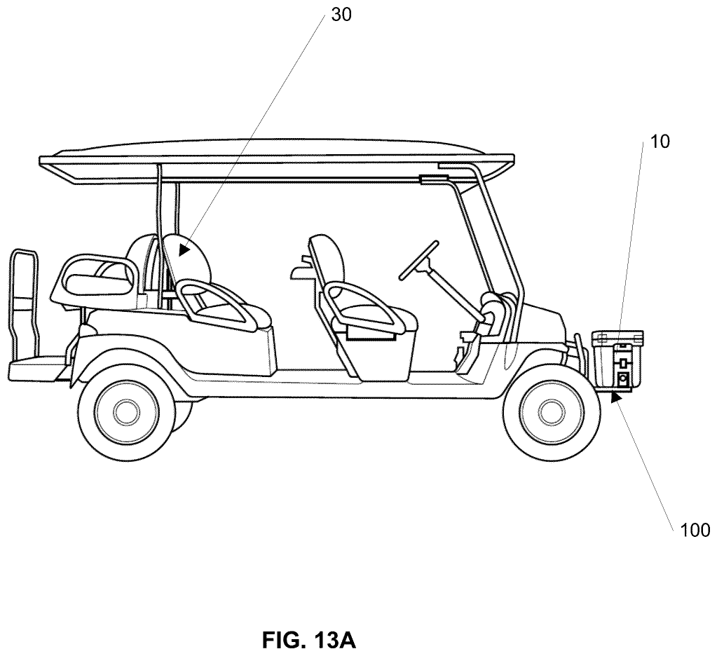

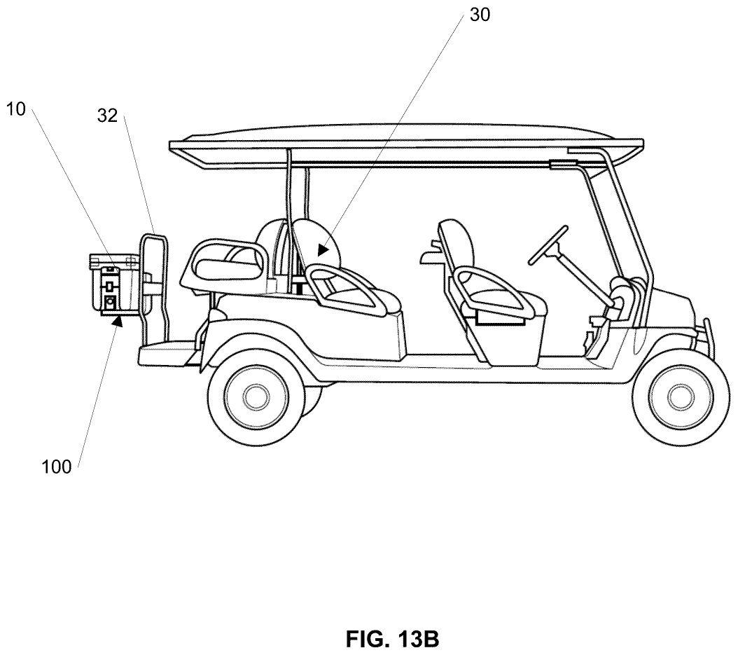

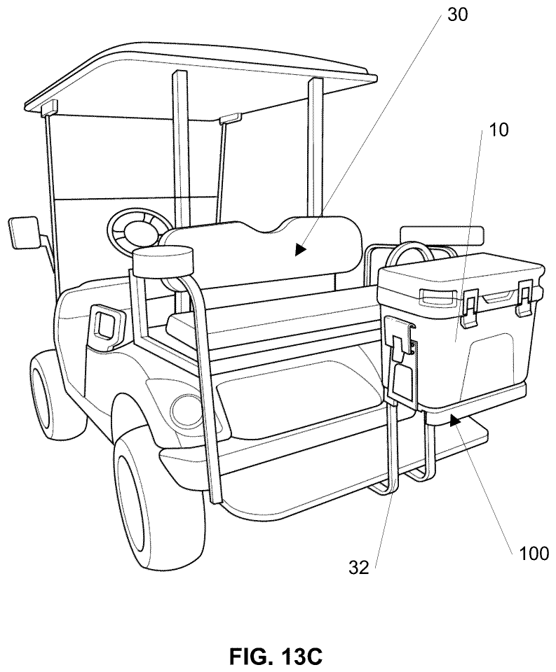

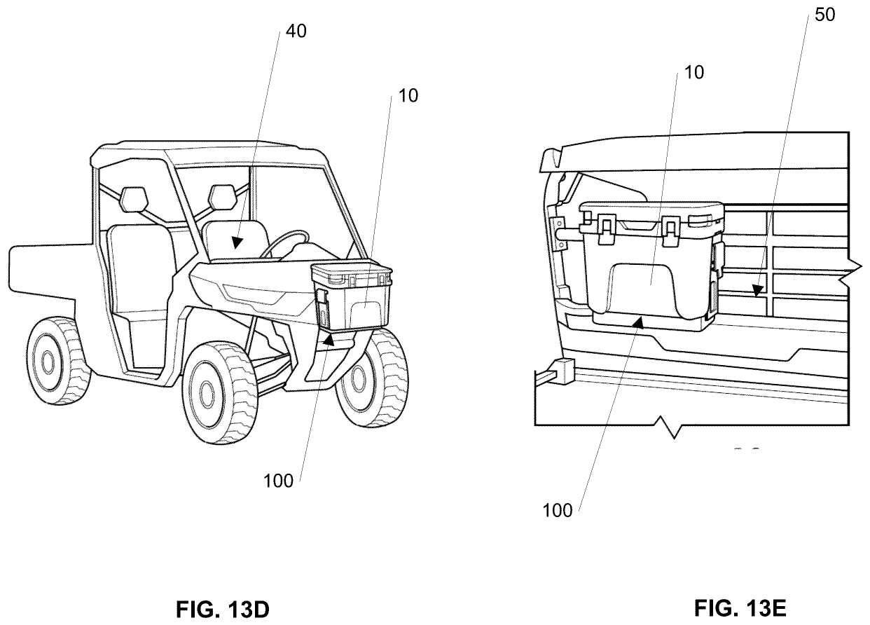

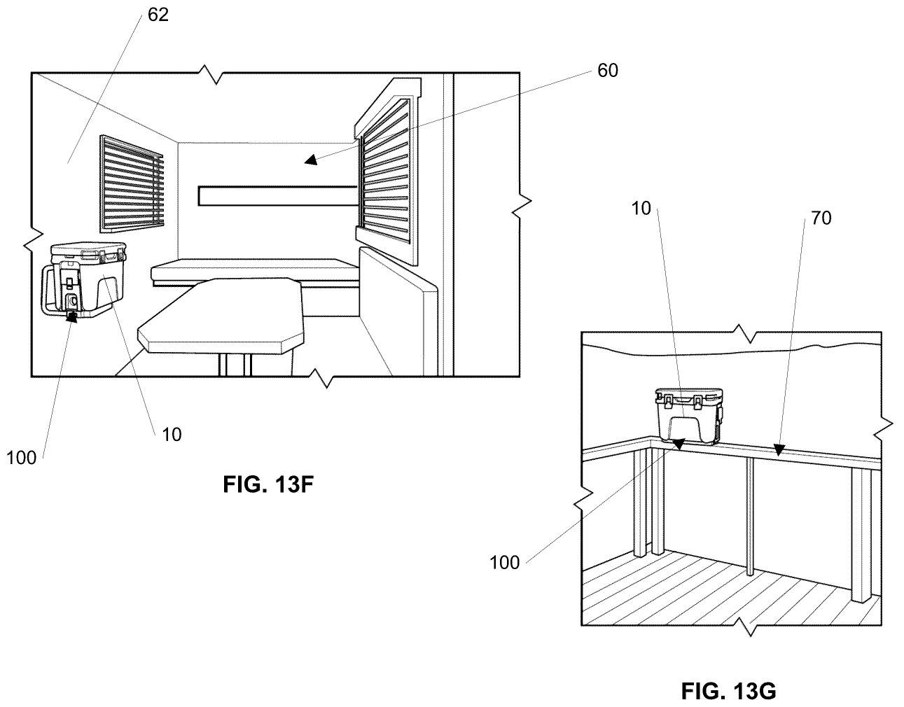

In some examples, the base plate 110, the bottom base 114, and the base pan 116 may be configured to attach to and/or engage with the vehicle, UTV, ATV, golf cart, or other mounting location. Additionally, the bottom base 114 and the base pan 116 may include a mounting configuration to provide a horizontal mount compatibility. In some examples, the bottom base 114 may include an opening 122 with the base pan 116 fitting over the opening 122, thereby creating a mounting space. The opening 122 and the base pan 116 may allow the base plate 110 and container mount system 100 to attach to horizontal surfaces, for example a rack on a vehicle such as an UTV, ATV, or golf cart (see FIG. 13E) or using a hitch bar (see example FIG. 3D), or attaching to a deck or fence (see FIG. 13G).

In some examples, and as depicted in FIGS. 3A and 3B, the opening 122 and the base pan 116 may be a rectangular cutout. In other examples, the opening 122 and the base pan 116 may be other shapes.

The base plate 110 and/or the base pan 116 may include one or more base plate mounting holes 124. In some examples, the base plate mounting holes 124 may be located within the base pan 116 and extend through the base pan 116 and into the opening 122. In other examples, the base plate mounting holes 124 may extend through the base plate 110. The base plate mounting holes 124 may be pre-drilled holes for mounting brackets for easy installation onto the vehicle, UTV, ATV, golf cart, or other mounting location.

In some examples, as shown in FIGS. 3C and 3D, the base plate mounting holes 124 may be spaced for U-bolts 125 or other hardware to be received and mounted while not interfering with the bottom of the container or cooler 10. FIG. 3C shows the container mount system 100 with a set of U-bolts 125 attached to the base plate mounting holes 124 and the base plate 110. FIG. 3D shows the container mount system 100 and U-bolts 125 with the container mount system and U-bolts 125 attached to a square tubing 16. The container mount system 100 may be secured to a hitch tongue on the vehicle, UTV, ATV, golf cart, or other mounting location and connected to a 2″ (or other size) square tubing 16 with the U-bolts 125.

The base plate mounting holes 124 may include a universal mounting pattern that allows for a variety of mount locations. The mounting space created by the opening 122 and the base pan 116 allows the base plate 110 and container mount system 100 to be attached to horizontal surfaces without interfering with the container or cooler 10 while attaching to the base plate 110 and container mount system 100. In some examples, the base pan 116 may include drain holes or drain openings 126 to prevent water from pooling from spills, leakage, or weather.

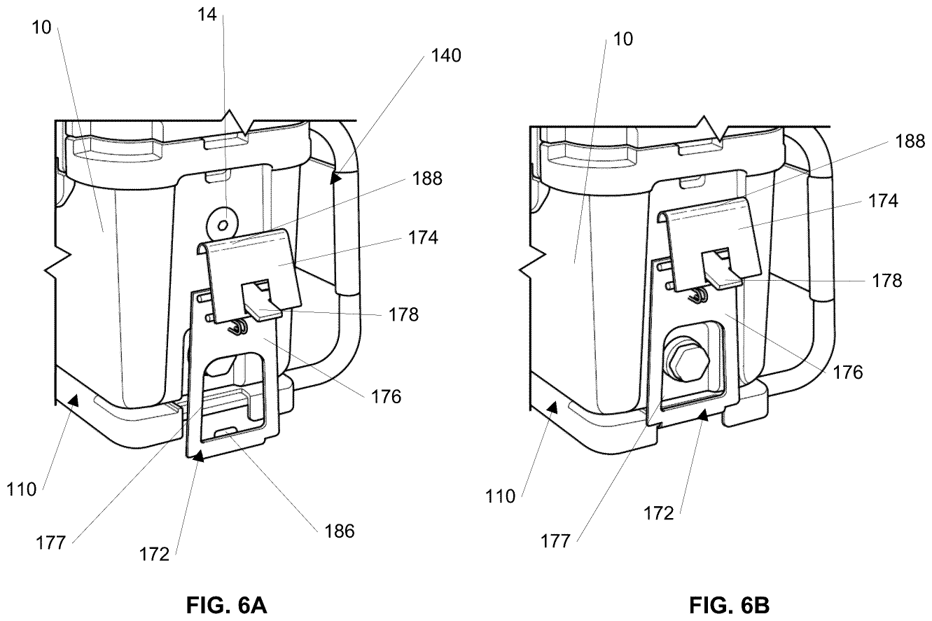

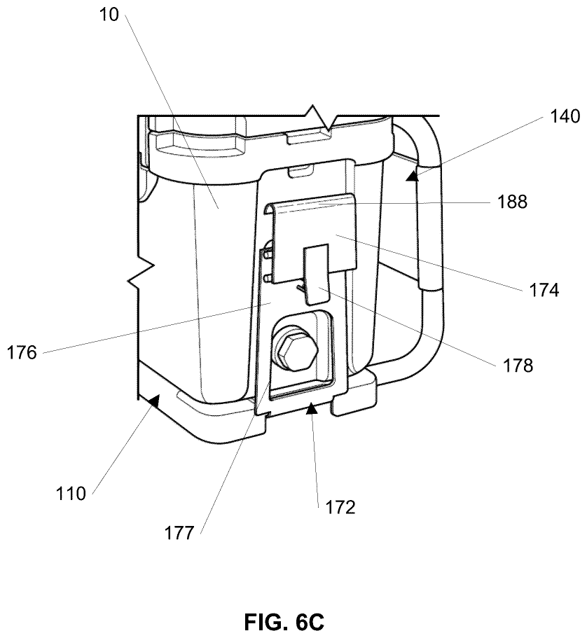

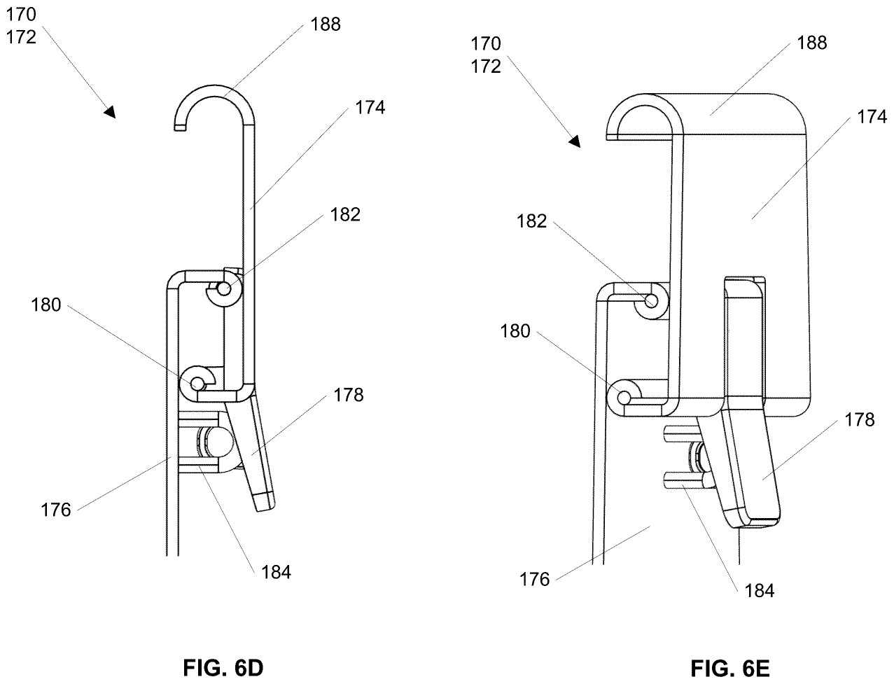

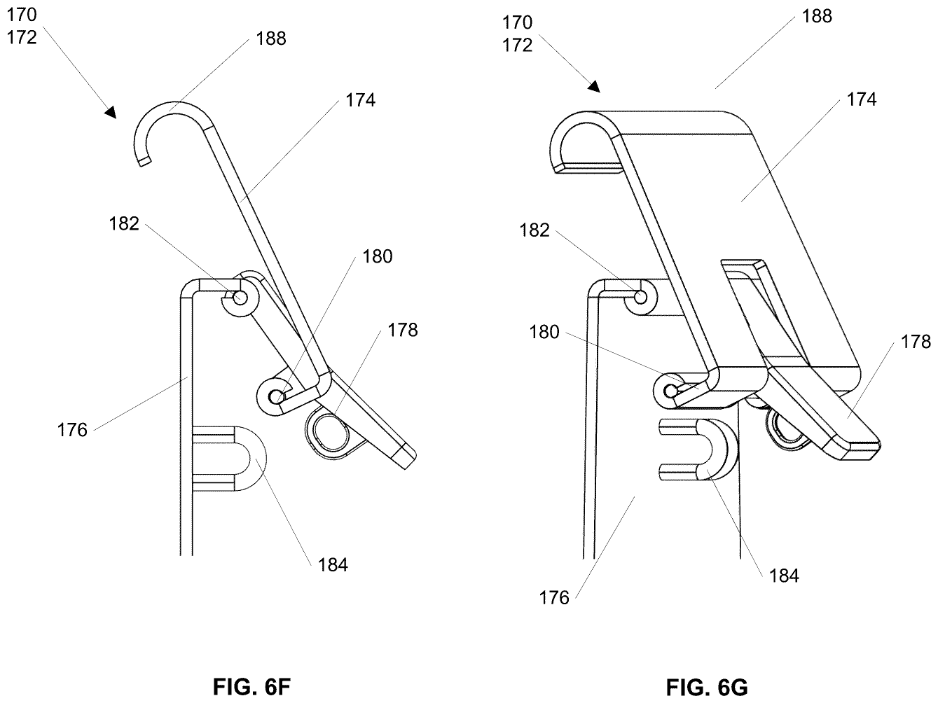

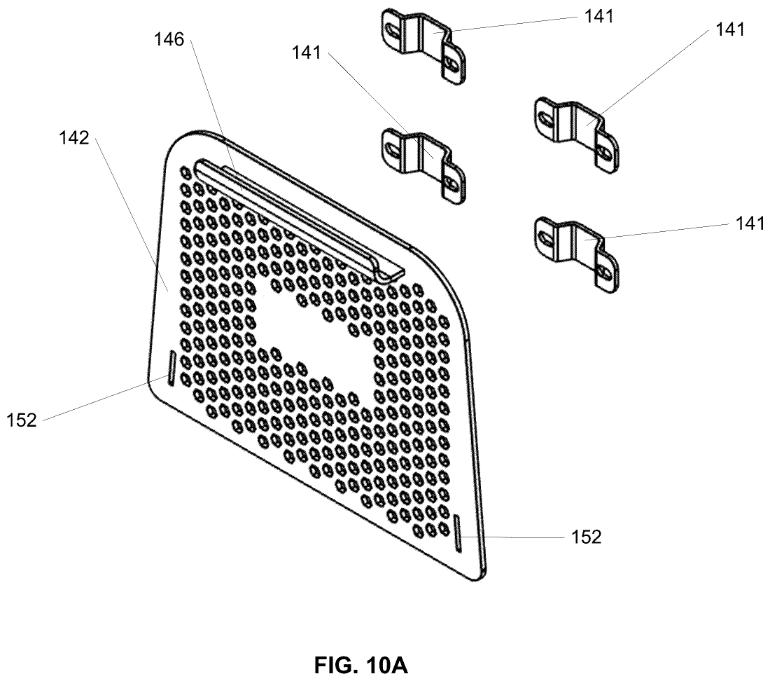

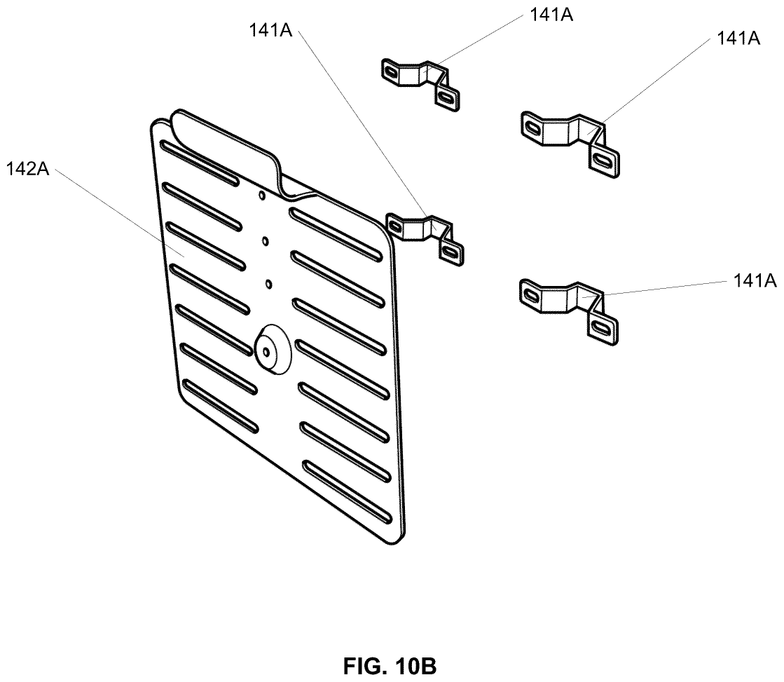

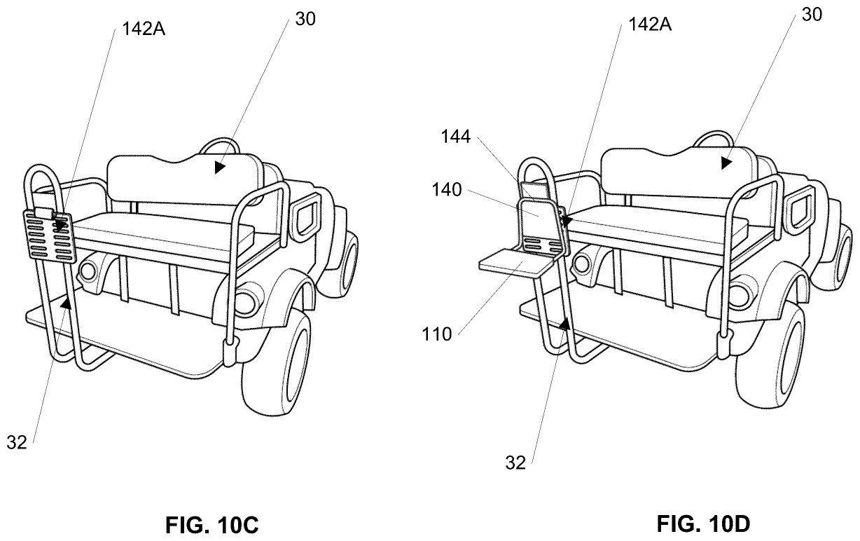

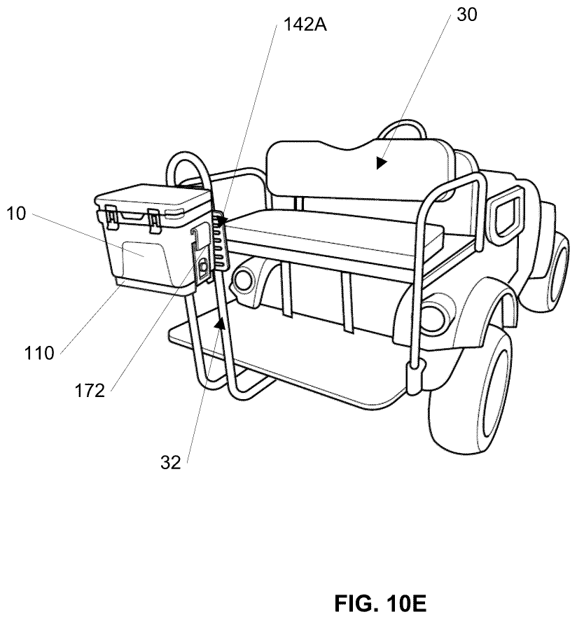

Additionally, the bottom base 114 may include one or more structures to engage with and attach to the latch assembly brackets 172 or the tie-down straps 20 to hold and secure the container or the cooler 10 to the container mount system 100. For example, the bottom base 114 may include a tie-down tab 128 that extends from the bottom base 114. As shown in FIGS. 3A and 3B, the tie-down tabs 128 may extend from each of the sides of the bottom base 114. The tie-down tabs 128 may include a tie-down slot 130 to engage with and attach to the latch assembly brackets 172 or the tie-down straps 20 to hold and secure the container or cooler 10 to the container mount system 100. This will be explained more below with reference to FIGS. 6A-6C, 10A, and 10B. Additionally, in some examples, the base plate 110 or the bottom base 114 may include a structure with a built-in bottle opener.

In some examples, the base plate 110 may be rectangular in shape. In still other examples, the base plate 110 may be substantially square in shape. Various other shapes of the base plate 110 may be used without departing from the invention.

In some examples, the base plate 110 may be constructed or formed from durable materials such as metal or reinforced plastic to withstand the weight of the container and the stresses encountered during transit. In some examples, the top base 112 may be formed from a reinforced plastic, with the bottom base 114 and base pan 116 may be formed from a sheet metal, such as stainless steel or other similar metals. In other examples, the base plate 110 may be constructed or formed with a powder coated steel frame with the top base 112 and a polymer deck. The base plate 110 may include a textured matte powder coat. In some examples, the base plate 110 may include a TPE pad to compress and provide grip with the container or cooler 10 when latched.

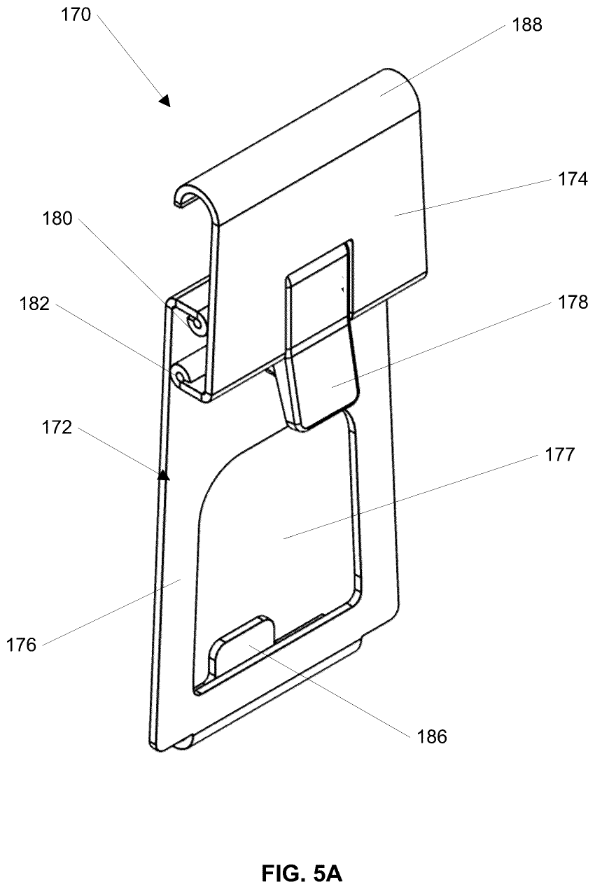

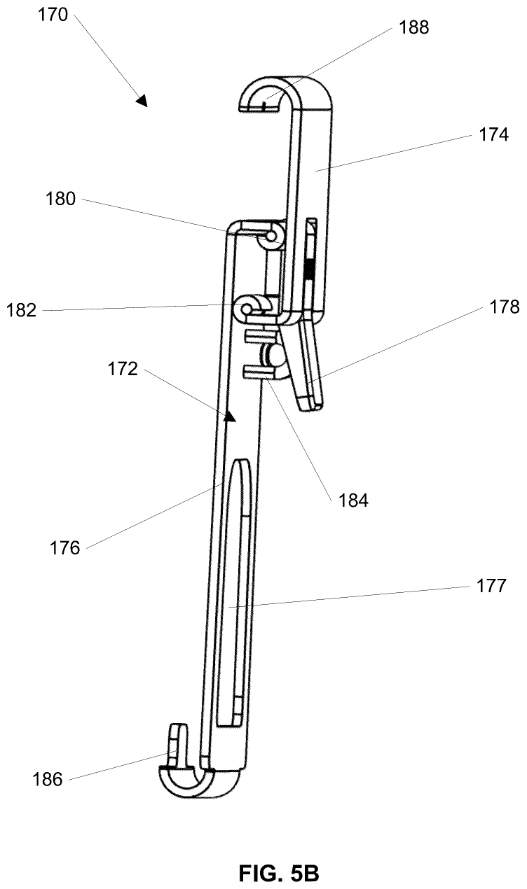

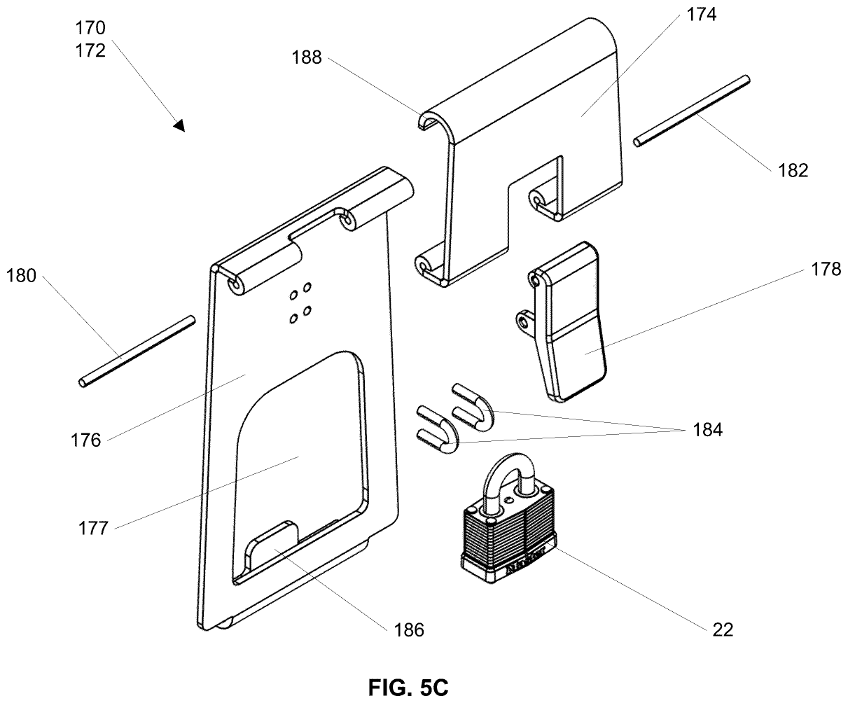

As shown in FIGS. 1A-2G, the container mount system 100 may comprise a latch assembly 170 that may attach to and extend from the sides of the base plate 110. The latch assembly 170 may be configured to hold down a container or cooler with minimal vibration for off-road transportation. FIGS. 5A and 5B show views of a latch assembly bracket 172 as part of the latch assembly 170. The latch assembly 170 may include two latch assembly brackets 172. FIG. 5C shows an exploded component view of the latch assembly bracket 172 as part of the latch assembly 170. 6A-6C show the latch assembly 170 in various configuration with a cooler 10. Each latch assembly bracket 172 may include an upper latch assembly 174, a lower latch assembly 176, and a latch 178 that provides a locking mechanism for securing the container or cooler 10 to the container mount system 100. The upper latch assembly 174 may be hingedly and/or pivotally attached to the lower latch assembly 176 by the latch 178 and an upper latch pin 180 and a lower latch pin 182. Each latch assembly bracket 172 may also include one or more locking loops 184 attached to the latch assembly bracket 172 and the lower latch assembly 176. The one or more locking loops 184 may be configured to receive a lock or a padlock 22 to securely lock the latch 178, thereby locking the latch assembly bracket 172 and locking the container or cooler 10 to the container mount system 100.

The latch assembly 170 may include two latch assembly brackets 172 that are attached to the base plate 110 and are positioned on either side of the container or cooler 10. Each latch assembly bracket 172 may feature a locking mechanism or clasp designed to engage with a corresponding element on the container or cooler, such as handles or rims or other structures to hold down the container or cooler tightly. The locking mechanism may include adjustable straps, clasps, or latches that securely hold the container or cooler in place.

In some examples, the lower latch assembly 176 may include an opening 177. The opening 177 may help enable drain plug access and locking in place with integrated lock assembly. The opening 177 in the lower latch assembly 176 may also help locate the container or cooler 10 while providing access to drain plug or spigot.

In some examples, the latch assembly 170 and latch assembly brackets 172 may be rectangular in shape. In still other examples, the latch assembly 170 and latch assembly brackets 172 may be various other shapes without departing from the invention.

In some examples, the latch assembly 170 and latch assembly brackets 172 may be constructed or formed from durable materials such as metal or reinforced plastic to withstand the weight of the container and the stresses encountered during transit. In some examples, the latch assembly 170 and latch assembly brackets 172 may be formed from a metal, such as stainless steel or other similar metals. In other examples, the latch assembly 170 and latch assembly brackets 172 may be constructed or formed with a powder coated steel frame, such as a textured matte powder coat. The latch assembly brackets 172, to include the upper latch assembly 174 and lower latch assembly 176 may be cut resistant and pad-lockable.

In some examples, the latch assembly 170 and latch assembly brackets 172 may be easily removed from the base plate 110 and stored separately from the base plate 110 and the rest of the container mount system 100. When not in use, the latch assembly 170 and latch assembly brackets 172 may be stored.

FIGS. 6A-6C illustrate the latch assembly 170 in various configurations with an example cooler 10 being mounted and secured to the container mount system 100. The latch assembly 170 may provide a quick attachment and removal with a familiar interface between the latch assembly 170 and the container or cooler 10. The latch assembly 170 may hold the container or cooler 10 under light compression to handle rugged driving conditions and off-road driving. FIG. 6A shows the lower latch assembly 176 aligned to the tie-down slot 130 on the base plate 110. As shown in FIG. 6A, the lower latch assembly 176 may include a lower bracket tab or extension 186 that corresponds to and engages with the tie-down slot 130 on the base plate 110. FIG. 6B shows the upper latch assembly 174 being lifted over and onto a post 14 on the container or cooler 10. The upper latch assembly 174 may pivot about the lower latch pin 182. The upper latch assembly 174 may include an upper bracket tab or extension 188 that corresponds to and engages with the post 14 on the container or cooler 10. The upper latch assembly 174 and the upper bracket tab or extension 188 may correspond to and engage with other structures on the container or cooler 10. FIG. 6C shows that latch 178 being closed, thereby pulling the upper latch assembly 174 and the upper bracket tab or extension 188 down onto the post 14 on the container or cooler 10. The latch 178 may closed by pivoting with the upper latch pin 180 and the lower latch pin 182. The closing of the latch 178 may cause tension and compression between the upper latch assembly 174 and the lower latch assembly 176 while securing and holding the container or cooler 10 in place on the container mount system 100.

The latch assembly 170 does not merely “pull down” but also includes an over-center feature that holds the latch 178 in place after activation and resists shock and vibrating forces that might tend to cause the latch 178 to unlatch. The use of a padlock 22 locks and stops the latch assembly 170 from unlatching once the padlock 22 is latched in place. FIGS. 6D-6G show the over-center feature and the geometry of the latch 178, with FIGS. 6D and 6E showing the latch 178 in the closed configuration and FIGS. 6F and 6G showing the latch in the open configuration. As shown in FIGS. 6D-6G, the lower latch pin 182 crosses the vertical plane defined by the upper latch pin 180 as the latch 178 rotates from closed to open, thereby creating the over-center feature that holds the latch 178 in place after activation and resists shock and vibrating forces that might tend to cause the latch 178 to unlatch.

The latch assembly 170 and engagement with the base plate 110 provides a theft-resistant strap configuration for the container or cooler 10 on the vehicle, UTV, ATV, golf cart, or other mounting location. Specifically, with the latch assembly 170, there are no externally facing fasteners by which the latch assembly brackets 172 could be removed when fastened to the container or the cooler 10. Accordingly, someone would potentially need to destroy the padlock 22 or latch assembly or latch assembly brackets 172 to unlock the container or cooler 10 to remove the container or cooler 10 through theft from the vehicle, UTV, ATV, golf cart, or other mounting location.

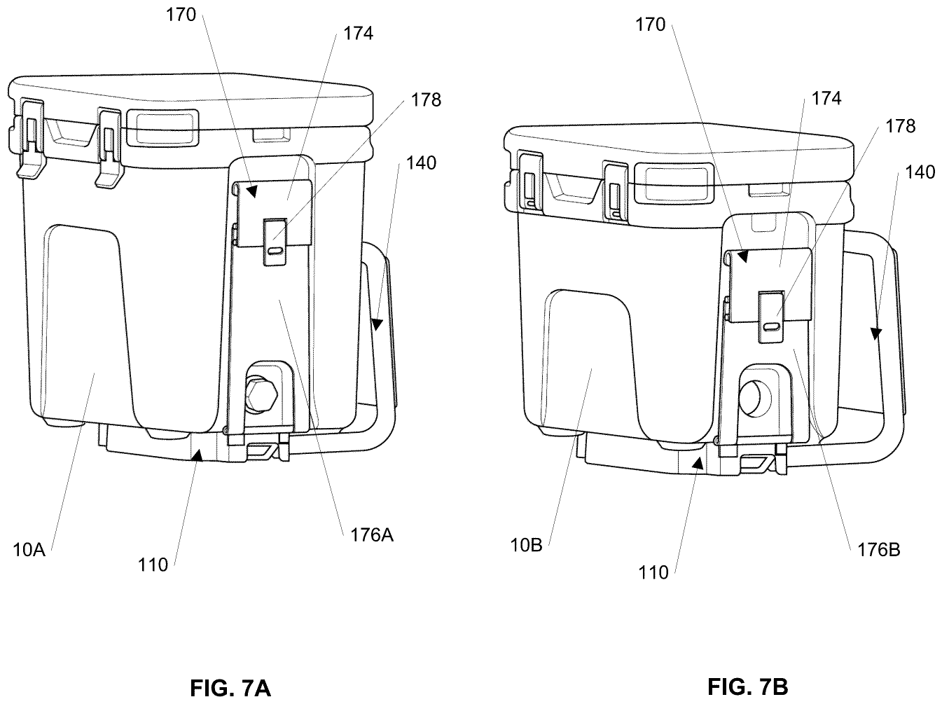

Additionally, in some examples, as shown in FIGS. 7A and 7B, the container mount system 100 may include different sized latch assembly brackets 172. As shown in FIG. 7A, for a larger container or cooler 10A, the latch assembly 170 may include may include a larger lower latch assembly 176A. As shown in FIG. 7B, the larger lower latch assembly 176A may be changed out for a smaller lower latch assembly 176B to secure a smaller container or cooler 10B. In other examples, the two latch assembly brackets 172 may be adjustable to accommodate containers or coolers of different sizes and shapes, providing flexibility for users.

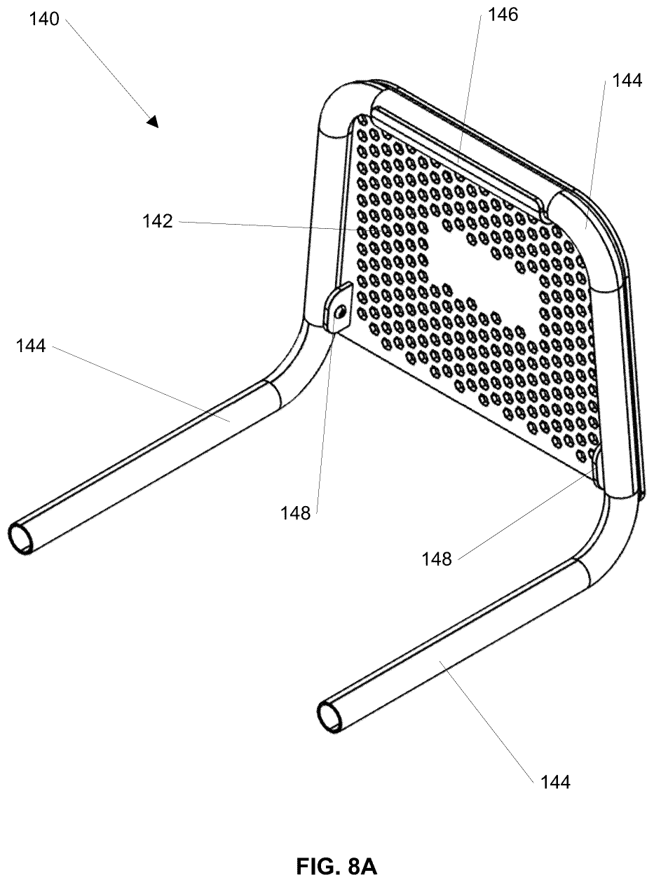

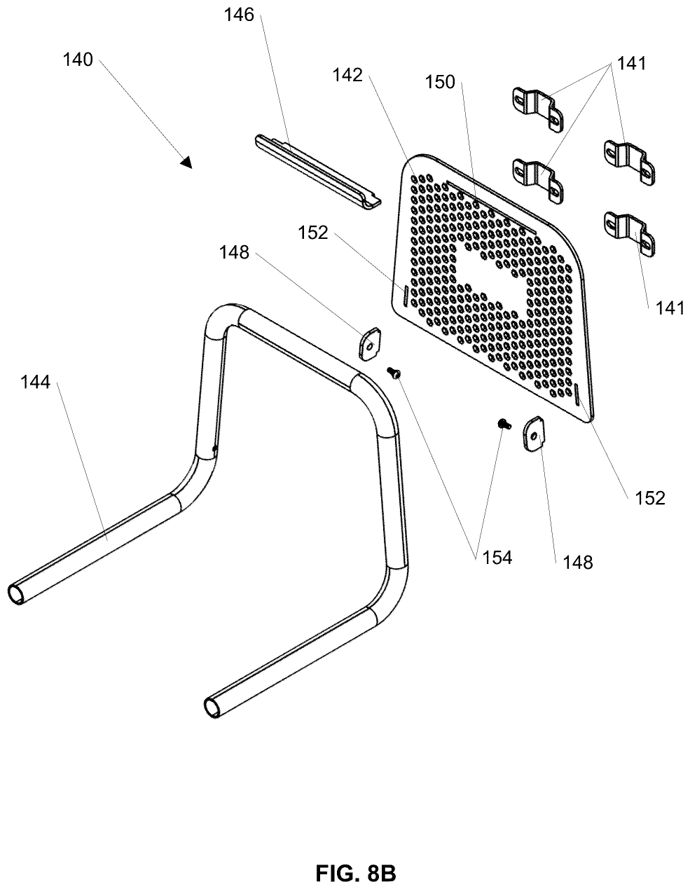

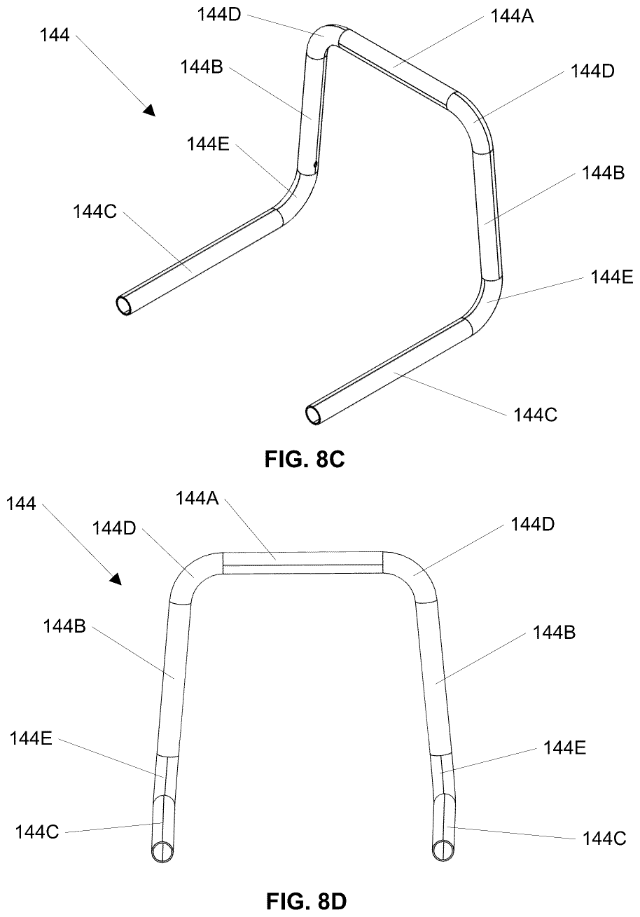

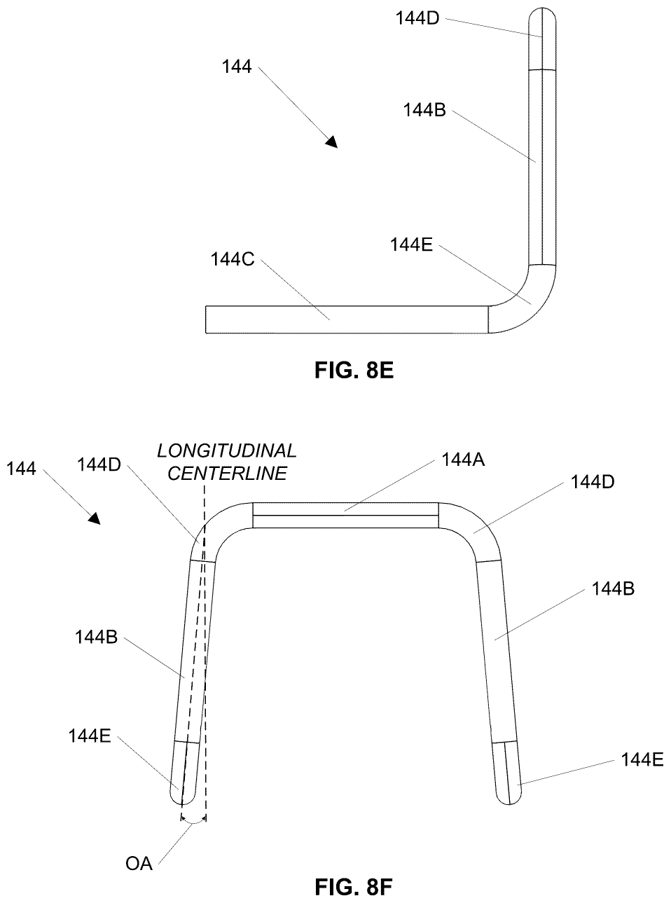

As shown in FIGS. 1A-2G, the container mount system 100 may comprise a back plate assembly 140 that may be positioned behind the container or cooler 10 and may be configured to reinforce the stability for the holding the container or cooler 10. FIG. 8A shows a view of a back plate assembly 140. FIG. 8B shows an exploded component view of the back plate assembly 140. The back plate assembly 140 may include a back plate 142 that attaches to a mount tubing 144 using a back plate horizontal bracket 146 and one or more retaining brackets 148 attached to the back plate 142. The back plate assembly 140 may also include one or more mount brackets 141 configured to attach to and engage with the back plate 142 and the portion of the vehicle, UTV, ATV, golf cart, or other mounting location.

As shown in FIGS. 8A and 8B, the back plate 142 may include a horizontal bracket slot 150 configured to receive the back plate horizontal bracket 146. The back plate 142 may also include one or more retaining bracket slots 152 configured to receive the retaining brackets 148. After the back plate 142 is mounted to a vehicle, UTV, ATV, or golf cart (as will be explained and detailed more in FIGS. 10A-10E) the back plate horizontal bracket 146 may be set in the horizontal bracket slot 150 at the top of the back plate 142. Additionally, the retaining brackets 148 may be set in the retaining bracket slots 152 located at the sides and bottom of the back plate 142. The mount tubing 144 may be set on the back plate horizontal bracket 146 located at the top of the back plate 142. The mount tubing 144 may then be rotated into position. The retaining brackets 148 may then be secured to the mount tubing 144 with fasteners 154, such as screws or other fasteners. The fasteners 154 may be recessed in between the mount tubing 144 to make the fasteners difficult to access while the container or cooler 10 is mounted on the container mount system 100.

As shown in FIGS. 8A through 8F, the mount tubing 144 may include various sections or components. FIG. 8C shows a front, perspective view of the mount tubing 144 and the various sections. FIG. 8D shows a front view of the mount tubing 144 and the various sections. FIG. 8E shows a side view of the mount tubing 144 and the various sections. FIG. 8F shows a back view of the mount tubing 144 and the various sections. In an exemplary embodiment shown in FIGS. 8C-8F, the mount tubing 144 may include a center arm 144A, two vertical arms 144B, and two lower arms 144C. The vertical arms 144B may be connected to the center arm 144A using two upper bends 144D. The two lower arms 144C may be connected to the vertical arms 144B using two lower bends 144E. Other configurations of sections and components may be utilized for the mount tubing 144.

The mount tubing 144 and the mount tubing components, 144A, 144B, 144C, 144D, 144E, 144F may be configured with a geometry for strength. In some examples, the mount tubing 144 may not include any 90-degree bends with respect to a longitudinal centerline (for example, as shown in FIG. 8F). The longitudinal centerline may be a line perpendicular to a plane of the back plate 142. Additionally, in some examples, the mount tubing 144 and the vertical arms 144B may include an offset in the angle OA of a bend in the tubing relative to 90 degrees, thereby splaying outward from the centerline of the mount tubing 144. For example, in some embodiments, an offset in the angle OA of the tubing of the vertical arms 144B with respect to a longitudinal centerline may be between about 5 degrees and about 15 degrees. In some embodiments, an offset in the angle OA of the vertical arms 144B with respect to the longitudinal centerline may be approximately 10 degrees. The geometry of the mount tubing 144 and the vertical arms 144B may provide additional strength and a natural tension in the mount tubing 144 outward to strengthen and secure the back plate assembly 140 and the container mount system 100.

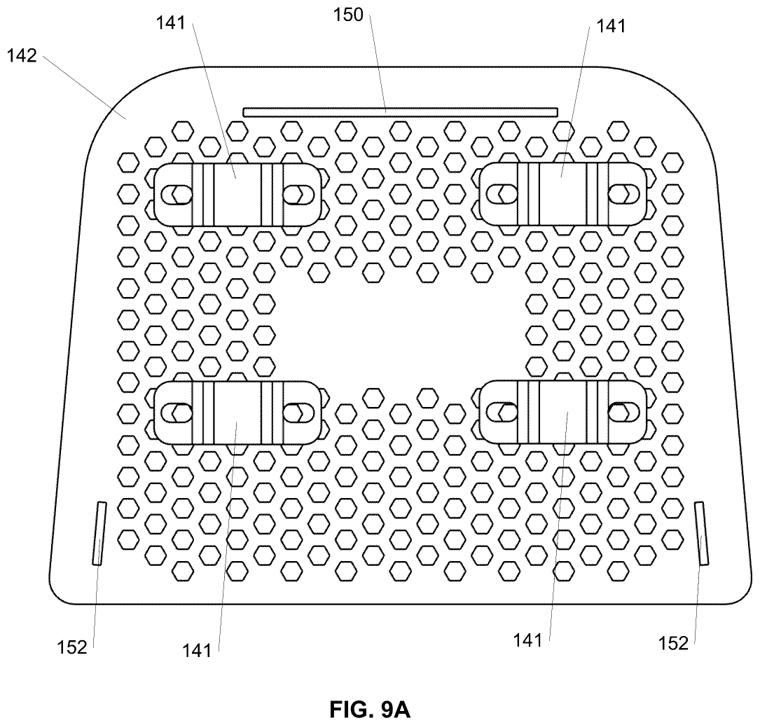

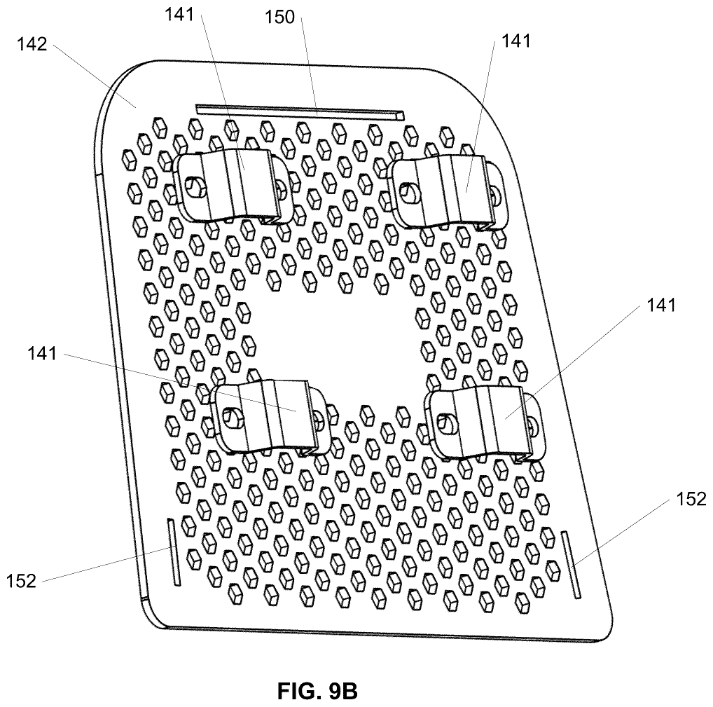

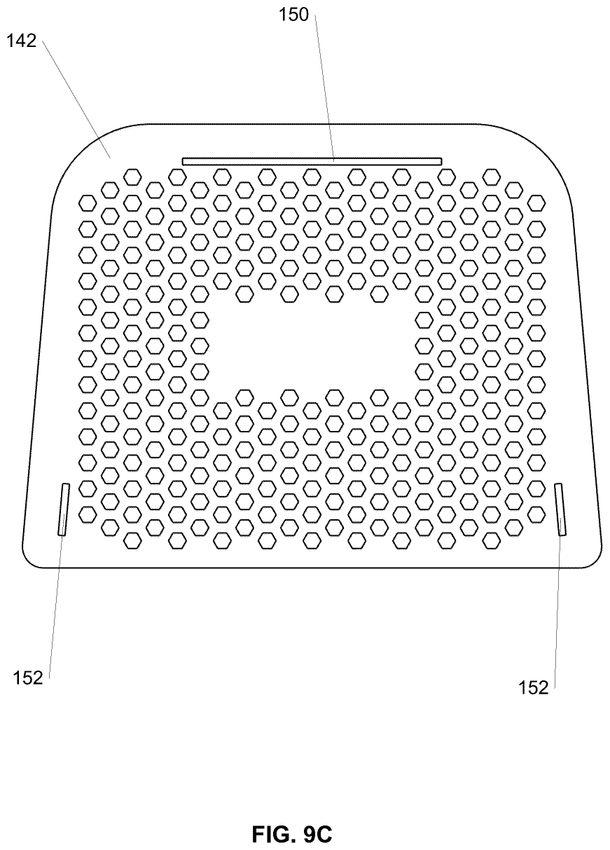

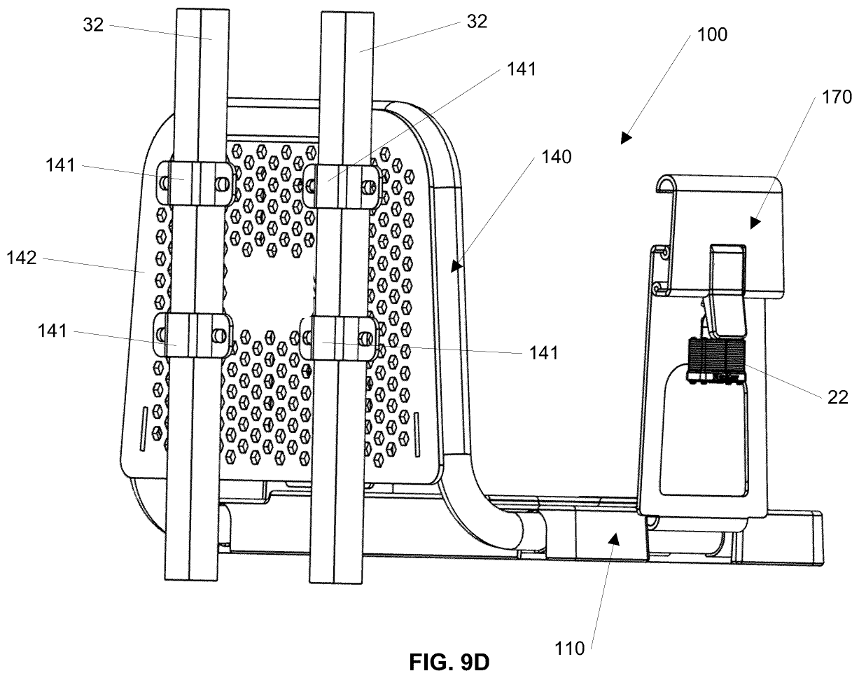

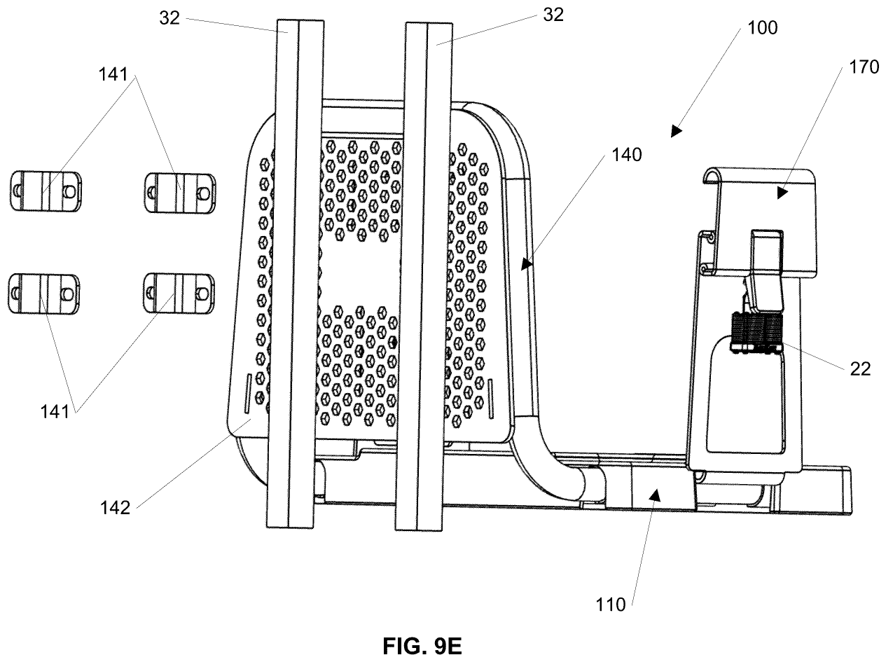

FIGS. 9A-9C show the back plate 142 and the mount brackets 141 configured to attach to and engage with the back plate 142 and the portion of the vehicle, UTV, ATV, golf cart, or other mounting location. As shown in FIGS. 9A-9C, the back plate 142 may include a hex grid pattern with a plurality of hexagonal-shaped holes that allows the flexibility to secure the mount brackets 141 in any location. The plurality of hexagonal-shaped holes may be also be located along the back plate 142 and spaced in a hexagonal pattern along the back plate 142. The hex grid pattern on the back plate 142 may also provide the flexibility and versatility to secure and utilize many different kinds of brackets, fasteners, or other hardware to attach the back plate to the vehicle, UTV, ATV, golf cart, or other mounting location. The hex grid pattern on the back plate 142 may allow the mount brackets 141 to be mounted at effectively any angle, including mounted to angled bars, vertical bars, or horizontal bars. The hex grid pattern on the back plate 142 may include a universal mounting pattern that allows for a variety of mount locations for the mount brackets 141.

FIGS. 9D and 9E show an example container mount system 100 mounted to posts or support bars 32 as part of the vehicle, UTV, ATV, golf cart, or other mounting location. The mount brackets 141 may be configured to secure to the back plate 142 while securing the container mount system 100 to the posts or support bars 32.

In some examples, the back plate assembly 140, the back plate 142, and the mount tubing 144 may be constructed or formed from durable materials such as metal or reinforced plastic to withstand the weight of the container and the stresses encountered during transit. In some examples, the back plate 142 and the mount tubing 144 may be formed from a metal, such as stainless steel or other similar metals. In other examples, the mount tubing 144 may be a steel tubing with a textured matte powder coat. In other examples, the back plate 142 may be formed from a sturdy steel with a textured matte powder coat.

In some examples, as explained above, the back plate assembly 140 may include a detachable back plate 142 or mounting plate. FIGS. 10A-10E depict exemplary back plates or mounting plates and an exemplary mounting process using the detachable back plate. FIG. 10A depicts the back plate 142 and the mount brackets 141. The back plate 142 in FIG. 10A includes a hex grid pattern that provides a universal mounting pattern that allows for a variety of mount locations. FIG. 10B depicts another exemplary back plate 142A and mount brackets 141A that can be used with the back plate 142A. The back plate 142A in FIG. 10B includes a slot grid pattern. The mount brackets 141, 141A may include four tapered mount brackets to maximize compatibility with different size round and square tubing. In some embodiments as shown in FIGS. 10A-10E, the mount brackets 141 may include slots allowing a position of a fastener within the slots to be adjusted, further increasing mounting flexibility with different sized and shaped round and square tubing.

FIG. 10C depicts the first step in the mounting process, mounting the back plate 142A to a structure on the vehicle, UTV, ATV, golf cart, or other mounting location. As shown in FIG. 10C, the back plate 142A may be mounted to support bars 32 on the golf cart 30 using the plurality of mount brackets 141A. The back plate 142A may be mounted to the support bars 32 with at least two mount brackets 141A and four fasteners.

FIG. 10D depicts the next step in the mounting process for the container mount system 100. As shown in FIG. 10D, the mount tubing 144 may be hung on the back plate horizontal bracket 146 the back plate 142A. The mount tubing 144 may then rotate into position and secured to the back plate 142A. The base plate 110 may then slide onto the arms of the mount tubing 144 and be secured to the back plate 142A.

FIG. 10E depicts the next step in the mounting process, mounting and securing the container or cooler 10 to the container mount system 100. As shown in FIG. 10E, the container or cooler 10 may be set onto the base plate 110 of the container mount system 100. The container or cooler 10 may be then secured to the container mount system 100 with tie down straps 20 or latch assembly brackets 172 to hold and secure the container or the cooler 10 to the container mount system 100. The tie down straps 20 or latch assembly brackets 172 may engage with and attach to the tie-down slots 130 of the base plate 110.

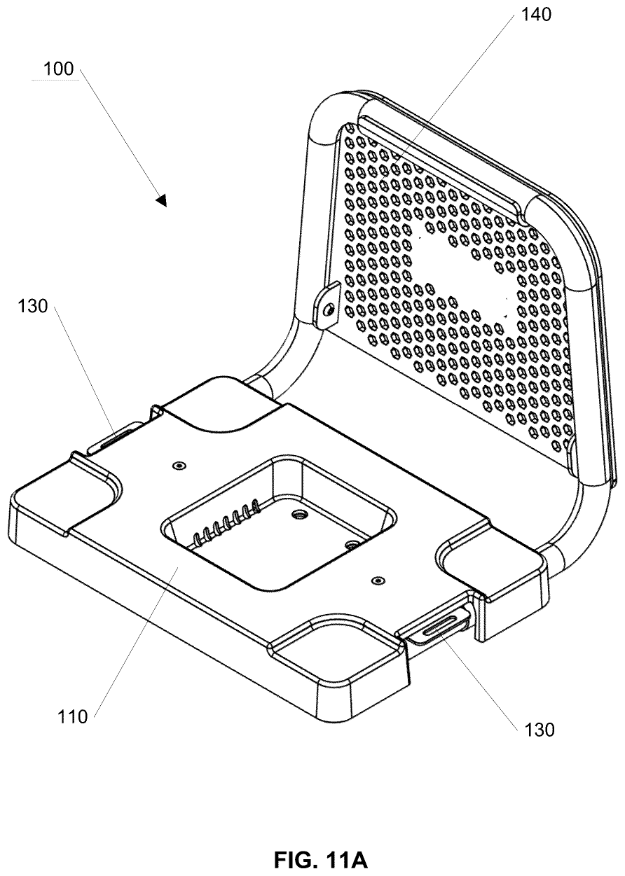

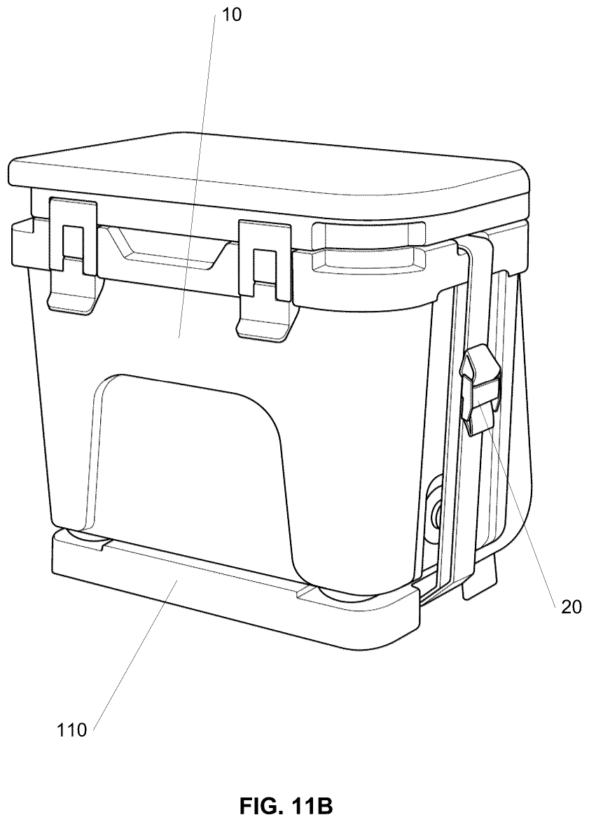

In some examples, as shown in FIGS. 11A and 11B, the container mount system 100 may include a base plate 110 and a back plate assembly 140 without the need for a latch assembly. The container mount system 100 used without the latch assembly may be utilized for a user without a need for drain plug access point or locking when securing or holding a container or cooler 10. As shown in FIG. 11B, the container or cooler 10 may be attached to and secured to the container mount system 100 using tie down straps 20. The tie down straps 20 may be secured to the container or cooler 10 and the tie-down slots 130 of the base plate 110.

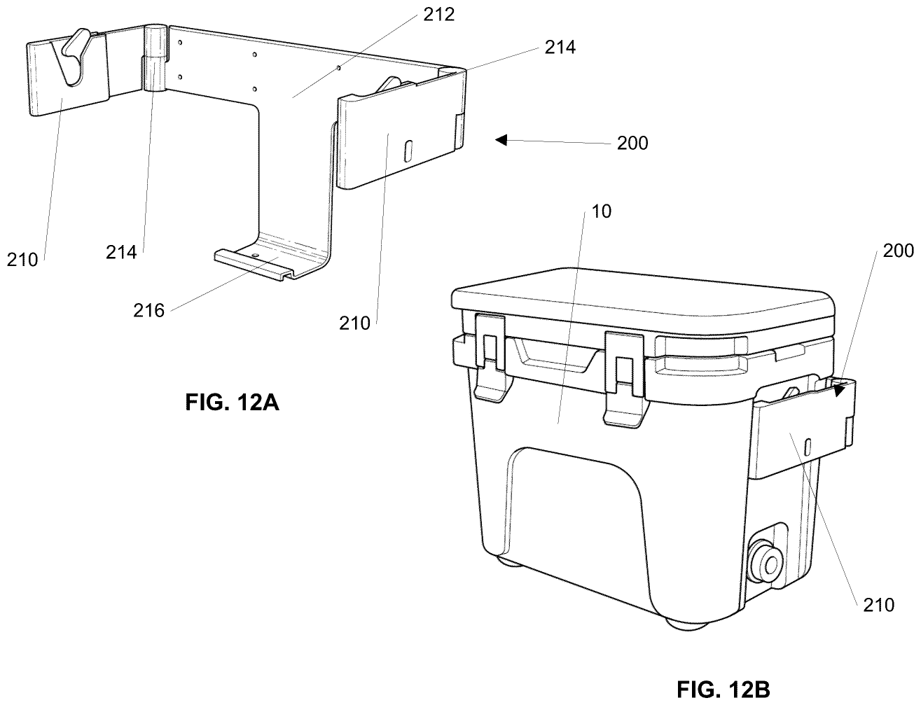

In other examples, FIGS. 12A and 12B depict another container mount system 200. FIG. 12A shows a perspective view of another container mount system 200 and FIG. 12B shows the container mount system 200 with a cooler 10. The container mount system 200 may include folding arms 210 for quick loading and unloading of the container or cooler 10. The folding arms 210 may be hingedly connected to a base 212 of the container mount system 200 using hinges 214. The base 212 may include a bottom support arm 216 to hold the bottom of a container or cooler 10. The container mount system 200 may be intended for a fender mount to vehicles, such as UTVs, ATVs, or golf carts. The container mount system 200 may include a drop-in design for the container or cooler 10 for ease of loading and unloading.

The container mount systems 100, 200 described and detailed may be mounted to various mounting options, such as vehicles, UTVs, ATVs, golf carts, or other mounting options. FIGS. 13A-13G depict various exemplary mounting options for the container mount system 100, 200. FIG. 13A depicts a container or cooler 10 attached to a container mount system 100 mounted on brush guards at the front of a golf cart 30. FIG. 13B depicts a container or cooler 10 attached to a container mount system 100 mounted on grab bars or support bars 32 at the rear of a golf cart 30. FIG. 13C depicts a container or cooler 10 attached to a container mount system 100 mounted on grab bars or support bars 32 at the rear of another exemplary golf cart 30. FIG. 13D depicts a container or cooler 10 attached to a container mount system 100 mounted on brush guards at the front of a UTV or ATV or side-by-side vehicle 40. FIG. 13E depicts a container or cooler 10 attached to a container mount system 100 attached to various mounting points in the cargo bed of a vehicle or pick-up truck 50. FIG. 13F depicts a container or cooler 10 attached to a container mount system 100 attached to a vertical surface, such as a wall 62 of a room 60 such as a garage or cabin. FIG. 13G depicts a container or cooler 10 attached to a container mount system 100 attached to a horizontal surface, such as a deck or rail 70.

In some embodiments, the container mount system may include anti-slip padding. Any one or more of the base plate 110, the back plate 142, and the latch assembly brackets 172 may be lined with non-slip padding to further enhance stability and prevent the container or cooler 10 from sliding or shifting during transportation or transit. The anti-slip padding may enhance stability and may help protect the container or cooler 10 from scratches or damage.

The container mount system may provide a variety of advantages.

Secure Attachment: The combination of the base plate, back plate, and latch assembly brackets with a latch and locking mechanism ensures that the container or cooler is firmly secured to the vehicle, UTV, ATV, golf cart, or other mounting location, minimizing the risk of accidental dislodging or spillage.

Versatility: The adjustable latch assembly brackets and the back plate/mounting plate allow the container mount system to accommodate containers or coolers of various sizes and shapes, providing flexibility for the users.

Durability: The container mount system is constructed from durable materials capable of withstanding the rigors of travel, rough terrain, and regular use, ensuring long-lasting performance.

In conclusion, the container mount system may offer an innovative and practical solution for users seeking to transport or store container or coolers securely on their vehicles, UTVs, ATVs, golf carts, or other mounting locations. The container mount system's sturdy construction, secure locking mechanisms, and adaptability make it an ideal accessory for containers and coolers.

The present disclosure is disclosed above and in the accompanying drawings with reference to a variety of examples. The purpose served by the disclosure, however, is to provide examples of the various features and concepts related to the disclosure, not to limit the scope of the invention. One skilled in the relevant art will recognize that numerous variations and modifications may be made to the examples described above without departing from the scope of the present disclosure.

### Exemplary Embodiments

A container mount system configured to hold a container or cooler on a vehicle, utility task vehicle (UTV), all-terrain vehicle (ATV), golf cart, or other mounting location, the container mount system comprising: a base plate, a back plate assembly attached to the base plate, wherein the back plate assembly attaches to the vehicle, UTV, ATV, golf cart, or other mounting location, and a pair of latch assembly brackets that are attached to and extend from the sides of the base plate, wherein the latch assembly brackets secure and lock the container or cooler on the container mount system.

The container mount system, wherein the base plate includes a top base, a bottom base, and a base pan attached to each other with one or more fasteners.

The container mount system, wherein the top base is configured to receive and hold the container or cooler and the top base include one or more indents configured to receive feet of the container or cooler.

The container mount system, wherein the one or more indents includes four indents located in the each of the corners of the top base, wherein each indent is formed with two sides connected with a curved section, and each indent includes a chamfer around the edge of each of the indents.

The container mount system, wherein the base plate and the base pan include one or more base plate mounting holes and a set of U-bolts attached to the base plate mounting holes.

The container mount system, wherein the base pan includes drain holes or drain openings to prevent water from pooling in the container mount system.

The container mount system, wherein the bottom base includes at least two tie-down tabs that extend from the sides of the bottom base, and the tie-down tabs include a tie-down slot to engage with and attach to the latch assembly brackets or tie-down straps to hold and secure the container or the cooler to the container mount system.

The container mount system, wherein the latch assembly brackets include an upper latch assembly, a lower latch assembly, and a latch that provides a locking mechanism for securing the container or cooler to the container mount system.

The container mount system, wherein the latch assembly includes an over-center feature that holds the latch in place after activation and resists shock and vibrating forces that cause the latch to unlatch.

The container mount system, wherein the upper latch assembly is hingedly attached to the lower latch assembly by the latch and an upper latch pin and a lower latch pin.

The container mount system, wherein the lower latch pin crosses a vertical plane defined by the upper latch pin as the latch rotates from closed to open, thereby creating the over-center feature that holds the latch in place after activation and resists shock and vibrating forces that cause the latch to unlatch.

The container mount system, wherein closing the latch causes tension and compression between the upper latch assembly and the lower latch assembly to secure and hold the container or cooler in place on the container mount system.

The container mount system, wherein the latch assembly brackets includes one or more locking loops configured to receive a lock or padlock to securely lock the latch, thereby locking the latch assembly bracket and locking the container or cooler to the container mounting system.

The container mount system, wherein the lower latch assembly includes a lower bracket tab that corresponds to and engage with the tie-down slot on the base plate.

The container mount system, wherein the upper latch assembly includes an upper bracket tab that engages with a post on the container or cooler.

The container mount system, wherein closing the latch pulls the upper latch assembly and the upper bracket tab down onto the post of the container or cooler.

The container mount system, wherein the back plate assembly includes a back plate that attaches to a mount tubing using a back plate horizontal bracket and one or more retaining brackets attached to the back plate.

The container mount system, wherein the back plate assembly includes a plurality of mount brackets configured to attach to and engage with the back plate and the portion of the vehicle, UTV, ATV, golf cart, or other mounting location.

The container mount system, wherein the mount tubing includes one or more sections and the one or more sections include a center arm, two vertical arms, and two lower arms, with the vertical arms connected to the center arm using two upper bends and the two lower arms connected to the vertical arms using two lower bends.

The container mount system, wherein the mount tubing does not include any 90-degree bends.

The container mount system, wherein the mount tubing includes an angular offset of the angle of the vertical arms between 5 and 15 degrees from a longitudinal centerline of the mount tubing.

The container mount system, wherein the back plate includes a hex grid pattern with a plurality of hexagonal-shaped holes that allows the flexibility to secure the one or more mount brackets in any location.

The container mount system, wherein the plurality of hexagonal-shaped holes are located along the back plate and spaced in a hexagonal pattern along the back plate.

The container mount system, wherein the container mount system is configured to hold and secure a cooler on a golf cart.

The container mount system, wherein the container mount system is configured to hold and secure a cooler on a utility task vehicle (UTV).

The container mount system, wherein the container mount system is configured to hold and secure a cooler on an all-terrain vehicle (ATV).

The container mount system, wherein the mounting process for the container mount system includes one or more of the following steps: mounting the back plate to a structure on the vehicle, UTV, ATV, golf cart, or other mounting location using at least two mount brackets and at least four fasteners; hanging the mount tubing on the back plat horizontal bracket of the back plate and then rotating the mount tubing into position and securing the mount tubing to the back plate; sliding the base plate onto arms of the mount tubing and securing the base plate to the back plate; mounting the container or cooler on the container mount system by locating the container or cooler on the base plate using the indents and the feet from the container or cooler; attaching the latch assembly brackets by engaging the lower bracket tab from the latch assembly brackets to the tie-down slots of the base plate; and securing the container or cooler to the container mount system with the latch assembly brackets by pivoting the latch on the latch assembly brackets and locking the container or cooler to the container mount system.

We claim:

1. A container mount system configured to hold a container or cooler on a vehicle, utility task vehicle (UTV), all-terrain vehicle (ATV), golf cart, or other mounting location, the container mount system comprising:
a base plate configured to hold the container or cooler;
a back plate assembly attached to the base plate, wherein the back plate assembly is configured to attach to the vehicle, UTV, ATV, golf cart, or other mounting location; and
a pair of latch assembly brackets attached to and extending from sides of the base plate, wherein the latch assembly brackets include an upper latch assembly, a lower latch assembly, and a latch that provides a locking mechanism configured to secure and lock the container or cooler to the container mount system.

2. The container mount system of claim 1, wherein the base plate includes a top base, a bottom base, and a base pan attached to each other with one or more fasteners.

3. The container mount system of claim 2, wherein the base pan includes drain holes or drain openings to prevent water from pooling in the container mount system.

4. The container mount system of claim 2, wherein the bottom base includes at least two tie-down tabs that extend from sides of the bottom base, and the tie-down tabs include a tie-down slot to engage with and attach to the latch assembly brackets or tie-down straps to hold and secure the container or the cooler to the container mount system.

5. The container mount system of claim 4, wherein the lower latch assembly includes a lower bracket tab that corresponds to and engage with the tie-down slot on the base plate.

6. The container mount system of claim 1, wherein the latch assembly brackets include an over-center feature that holds the latch in place after activation and resists shock and vibrating forces that cause the latch to unlatch.

7. The container mount system of claim 6, wherein the upper latch assembly is hingedly attached to the lower latch assembly by the latch and an upper latch pin and a lower latch pin.

8. The container mount system of claim 7, wherein the lower latch pin crosses a vertical plane defined by the upper latch pin as the latch rotates from closed to open, thereby creating the over-center feature that holds the latch in place after activation and resists shock and vibrating forces that cause the latch to unlatch.

9. The container mount system of claim 1, wherein closing the latch causes tension and compression between the upper latch assembly and the lower latch assembly to secure and hold the container or cooler in place on the container mount system.

10. The container mount system of claim 1, wherein the latch assembly brackets includes one or more locking loops configured to receive a lock or padlock to securely lock the latch, thereby locking the latch assembly brackets and locking the container or cooler to the container mounting system.

11. The container mount system of claim 1, wherein the upper latch assembly includes an upper bracket tab that engages with a post on the container or cooler.

12. The container mount system of claim 11, wherein closing the latch pulls the upper latch assembly and the upper bracket tab down onto the post of the container or cooler.

13. A container mount system configured to hold a container or cooler on a vehicle, utility task vehicle (UTV), all-terrain vehicle (ATV), golf cart, or other mounting location, the container mount system comprising:
a base plate with a top base configured to receive and hold the container or cooler and the top base includes one or more indents configured to locate and center feet or portions of a bottom of the container or cooler and accommodate and accept differences in width and length spacing between the feet of different containers or coolers, wherein the one or more indents includes four indents located in each corner of the top base;
a back plate assembly attached to the base plate, wherein the back plate assembly is configured to attach to the vehicle, UTV, ATV, golf cart, or other mounting location; and
a pair of brackets attached to and extending from the base plate, wherein the brackets secure the container or cooler on the container mount system.

14. The container of claim 13, wherein each indent is formed with two sides connected with a curved section.

15. The container of claim 13, wherein each indent includes a chamfer around an edge of each of the indents.

16. A container mount system configured to hold a container or cooler on a vehicle, utility task vehicle (UTV), all-terrain vehicle (ATV), golf cart, or other mounting location, the container mount system comprising:
a base plate configured to hold the container or cooler;
a back plate assembly attached to the base plate, wherein the back plate assembly is configured to attach to the vehicle, UTV, ATV, golf cart, or other mounting location, the back plate assembly comprising:
a back plate that attaches to a mount tubing using a back plate horizontal bracket and one or more retaining brackets attached to the back plate, wherein the mount tubing includes one or more sections and the one or more sections include a center arm, two vertical arms, and two lower arms, wherein the vertical arms are connected to and extend from each end of the center arm using two upper bends and the two lower arms are connected to and extend from the vertical arms using two lower bends, and
a plurality of mount brackets configured to attach to and engage with the back plate and a portion of the vehicle, UTV, ATV, golf cart, or other mounting location; and
a pair of brackets attached to and extending from the base plate, wherein the brackets secure the container or cooler on the container mount system.

17. The container mount system of claim 16, wherein the mount tubing does not include any 90-degree bends.

18. The container mount system of claim 17, wherein the mount tubing includes an angular offset of an angle of the vertical arms between 5 and 15 degrees from a longitudinal centerline of the mount tubing.

19. The container mount system of claim 16, wherein the back plate includes a hex grid pattern with a plurality of hexagonal-shaped holes that allows a flexibility to secure one of the plurality of mount brackets in any location.

20. The container mount system of claim 19, wherein the plurality of hexagonal-shaped holes are located along the back plate and spaced in a hexagonal pattern along the back plate.
